(19) United States
(12) Patent Application Publication
(10) Pub. No.: US 2026/0331806 A1
(43) Pub. Date: Oct. 22, 2026

(54) VERSATILE ELECTRICAL CONNECTOR AND CONNECTOR ASSEMBLY

(71) Applicant: Amphenol Aorora Technology (Huizhou) Co., Ltd., Huizhou (CN)

(72) Inventors: Xiaohong Zhu, Huizhou (CN); Hancheng Chen, Huizhou (CN); Shan Huang, Huizhou (CN)

(73) Assignee: Amphenol Aorora Technology (Huizhou) Co., Ltd., Huizhou (CN)

(21) Appl. No.: 19/468,226

(22) Filed: Feb. 3, 2026

Related U.S. Application Data
(63) Continuation of application No. PCT/CN2024/109792, filed on Aug. 5, 2024.

(30) Foreign Application Priority Data
Aug. 4, 2023 (CN) 202322097245.8
Jul. 22, 2024 (CN) 202421741340.5

(51) Int. Cl. H01R 12/77; H01R 24/60

(52) U.S. Cl. CPC H01R 12/771; H01R 24/60

(57) ABSTRACT

Versatile electrical connectors and connector assemblies. A connector includes a housing having a cavity, and a terminal assembly disposed in the cavity. The terminal assembly includes a base separating the cavity into first and second slots each configured to receive an electrical device, and terminals each having a mounting portion fixedly held by the base and arms extending in opposite directions from the mounting portion and movable relative to the base. For each terminal, at least one arm includes a mating portion protruding into the first slot to contact a first electrical device inserted therein, and at least one arm includes another mating portion protruding into the second slot to contact a second electrical device inserted therein. Techniques described herein enable the connectors to provide reliable interconnections between various types of electrical devices (e.g., flexible cables and/or twinax cables) in a harsh environment such as one presented by an automobile.

### CROSS-REFERENCE TO RELATED APPLICATIONS

This application is a continuation of International Application No. PCT/CN2024/109792, filed on Aug. 5, 2024, entitled “ELECTRICAL CONNECTOR AND CONNECTOR ASSEMBLY,” which claims priority to and the benefit of Chinese Patent Application No. 202421741340.5, filed on Jul. 22, 2024. International Application No. PCT/CN2024/109792 also claims priority to and the benefit of Chinese Patent Application No. 202322097245.8, filed on Aug. 4, 2023. The contents of these applications are incorporated herein by reference in their entirety.

### TECHNICAL FIELD

This application generally relates to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, which may be joined with electrical connectors. Electrical connectors may be used for interconnecting electronic assemblies so that the electronic assemblies may operate together as part of a system. Connectors, for example, may be mounted on printed circuit boards within two assemblies that are connected by mating the connectors. In other systems, it may be impractical to join two printed circuit boards by directly mating connectors on those printed circuit boards. For example, when the system is assembled, those printed circuit boards may be separated by too great a distance for a direct connection between connectors mounted to the printed circuit boards.

In some systems, connections between electronic assemblies may be made through cables. The cables may be terminated with connectors that mate with connectors mounted on a printed circuit board. In this way, connections between electronic assemblies may be made by plugging a connector that is part of a cable assembly into a board connector that is mounted to the printed circuit board. In other system architectures, a connector terminating a cable may be mated with another connector terminating another cable.

An example of a system in which assemblies are connected through cables is a modern automobile. For example, automotive vehicles include electronic control units (ECUs) for controlling various vehicle systems, such as the engine control unit, transmission control unit (TCUs), battery management system (BMS), cell sensing circuit (CSC), security systems, emissions control system, lighting control units, advanced driver assistance systems (ADAS), entertainment systems, navigation systems, and cameras. These electronic control units may be manufactured as separate assemblies. To simplify manufacture of an automobile, the assemblies may be connected via cables that are terminated with connectors that enable connections to mating board connectors terminating other cables or attached to printed circuit boards within the assemblies.

An automobile presents a harsh environment for an electrical connector. The automobile may vibrate, which can cause a connector to unmate and cease working entirely. Even if the vibration does not completely prevent operation of the connector, it can cause electrical noise, which can interfere with operation of electronics joined through interconnects including connectors. Noise, for example, may result from relative movement of components within connectors, which can change the electrical properties of the connector. Variations in the electrical properties, in turn, cause variation in the signals passing through the interconnect, which is a form of noise that interferes with processing the underlying signal.

In an automotive environment, electrical noise might also arise from automotive components that generate electromagnetic radiation. That radiation can couple to the conductive structures of a connector, creating noise on any signals passing over those conductive structures. In an automobile, any of a number of components might generate electromagnetic radiation, such as spark plugs, alternators or power switches. Noise can be particularly disruptive for high speed signals such as those use to communicate data over an automobile network.

### SUMMARY

Aspects of the present disclosure relate to versatile electrical connectors and connector assemblies.

Some embodiments relate to an electrical connector configured for electrically connecting a first electrical device and a second electrical device. The electrical connector may comprise a housing comprising a cavity extending in a first direction; a base separating the cavity of the housing into first and second slots spaced apart in the first direction, the first and second slots configured to receive the first and second electrical devices, respectively; and a plurality of electrical terminals, each of the plurality of electrical terminals comprising a mounting portion fixedly held by the base, and first and second arms extending in opposite directions from the mounting portion and movable relative to the base, the first arm comprising a mating portion protruding into the first slot, and the second arm comprising a mating portion protruding into the second slot.

Optionally, each of the plurality of electrical terminals comprises third and fourth arms extending in the opposite directions from the mounting portion and movable relative to the base, the third arm extending parallel to the first arm and offset from the first arm in a second direction perpendicular to the first direction and comprising a mating portion protruding into the first slot, the fourth arm extending parallel to the second arm and offset in the second direction from the second arm and comprising a mating portion protruding into the second slot.

Optionally, for each of the plurality of electrical terminals: the first arm extends farther from the mounting portion than the third arm in the first direction such that contact portions of the mating portions of the first and third arms are spaced apart in the first direction, and the second arm extends farther from the mounting portion than the fourth arm in the first direction such that contact portions of the mating portions of the second and fourth arms are spaced apart in the first direction.

Optionally, the contact portions of the mating portions of the first, second, third and fourth arms are aligned in the first direction.

Optionally, the mating portions of the first and second arms each have a first inclined surface extending obliquely in the second direction from the respective contact portion to a free end of the respective arm in the first direction; and the mating portions of the third and fourth arms each have a second inclined surface extending obliquely in the second direction from the respective contact portion to a free end of the respective arm in the first direction.

Optionally, for each of the plurality of electrical terminals: the mounting portion comprises a first surface abutting the base, and the first and second arms extends from or near the first surface of the mounting portion.

Optionally, the first surface of the mounting portion comprises at least one first protrusion protruding in the second direction; and the base comprises at least one first recess configured to receive the at least one first protrusion.

Optionally, the mounting portion comprises a second surface opposite to the first surface and at least two second protrusions protruding from the second surface, the at least two second protrusions spaced apart in the first direction.

Optionally, the base comprises a platform disposed between the first slot and the second slot; the platform comprises a plurality of ribs each extending in the first direction and protruding between adjacent terminal channels; and the base separates each of the first and second slots into subslots in the second direction.

Some embodiments relate to a connector assembly. The connector assembly may comprise a first electrical device comprising a plurality of first electrical terminals; a second electrical device comprising a plurality of second electrical terminals; and an electrical connector comprising a housing comprising a first slot and a second slot, and a plurality of electrical terminals, each of the plurality of electrical terminals comprising a first arm having a mating contact portion in the first slot and contacting a respective first electrical terminal of the first electrical device, and a second arm having a mating contact portion in the second slot and contacting a respective second electrical terminal of the second electrical device.

Optionally, each of the first and second electrical devices comprises a flat cable terminal assembly having a plurality of flat cable terminals or a receptacle terminal assembly having a plurality of receptacle electrical terminals.

Optionally, the housing of the electrical connector comprises a support portion disposed adjacent to the first slot and comprising a slit in communication with the first slot; and the first electrical device comprises a flat cable terminal assembly partially inserted into the first slot through the slit.

Optionally, the second electrical device comprises a receptacle terminal assembly having a plurality of receptacle electrical terminals.

Optionally, the flat cable terminal assembly is a flexible flat cable (FFC) or a flexible printed cable (FPC).

Some embodiments relate to an electrical connector. The electrical connector may comprise a housing comprising a cavity extending in a first direction; and a terminal assembly disposed within the cavity. The terminal assembly may comprise a base comprising a first base surface and a second base surface opposite to each other in a second direction perpendicular to the first direction, at least one of the first base surface and the second base surface having a plurality of terminal channels extending into the base in the second direction, the plurality of terminal channels spaced apart in a third direction perpendicular to both the first direction and the second direction, and a plurality of electrical terminals disposed in respective terminal channels of the plurality of terminal channels of the base, each of the plurality of electrical terminals comprising a retention portion, a pin portion extending from the retention portion and out of the respective terminal channel in the first direction, and an arm portion extending from the retention portion and opposite to the pin portion into a slot between the at least one base surface and an opposing inner surface of the housing, the arm portion configured to deflect toward a bottom of the respective terminal channel upon an insertion of a mating electrical device.

Optionally, the base comprises a first portion having a first surface portion, and a second portion connected to the first portion in the first direction and having a second surface portion; the first surface portion is offset toward the inner surface of the housing in the second direction from the second surface portion; and the slot is bounded between the second surface portion and the inner surface of the housing.

Optionally, for each of the plurality of electrical terminals: the retention portion is received within a channel segment of the respective terminal channel that is within the first portion of the base, the arm portion is received within a channel segment of the respective terminal channel that is within the second portion of the base, and the pin portion protrudes out from the first portion of the base in the first direction.

Optionally, the arm portion comprises a first arm extending from the retention portion and comprising a first arm contact portion, and a second arm extending from the retention portion parallel to the first arm and offset from the first arm in the second direction away from the bottom of the respective terminal channel to form a gap between the second arm and the first arm.

Optionally, the second arm comprises a second arm contact portion; and the first and second arm contact portions are aligned and spaced apart in the first direction and protrude out of the respective terminal channel by a same distance.

Some embodiments relate to a connector assembly. The connector assembly may comprise the electrical connector described herein, and a flat cable terminal assembly comprising a plurality of flat cable terminals coupled to respective electrical terminals of the plurality of electrical terminals of the electrical connector.

Some embodiments relate to an electrical connector configured for electrically connecting a first electrical device and a second electrical device and comprising: a connector housing made of an insulating material and bounding a housing cavity extending through the connector housing in a first direction; and a terminal assembly disposed within the housing cavity, the terminal assembly comprising a base and a plurality of electrical terminals, the base comprising opposite first and second base surfaces in a second direction perpendicular to the first direction and a plurality of terminal channels extending from at least one of the base surfaces into the base in the second direction, the plurality of terminal channels spaced apart in a third direction perpendicular to both the first and second directions and each elongated in the first direction, the at least one base surface opposite in the second direction to an inner surface of the connector housing bounding the housing cavity to bound therebetween first and second slots spaced apart in the first direction, and the first and second slots configured for receiving a portion of the first electrical device and a portion of the second electrical device, respectively, wherein each of the plurality of electrical terminals is received within a respective one of the plurality of terminal channels and comprises: a mounting portion configured to retain the electrical terminal in a corresponding terminal channel; and first and second arms extending oppositely from the mounting portion, each of the first and second arms: having an initial void from a bottom surface of the respective terminal channel that allows the arm to deflect toward the bottom surface of the respective terminal channel; and comprising a mating portion protruding out of the respective terminal channel toward the inner surface, and the mating portion of the first arm protruding into the first slot and the mating portion of the second arm protruding into the second slot.

Optionally, each of the plurality of electrical terminals further comprises: a third arm extending from the mounting portion in parallel with the first arm and offset from the first arm in the second direction away from the bottom surface of the terminal channel to allow the third arm to deflect toward the first arm into a gap between the third arm and the first arm; and a fourth arm extending from the mounting portion in parallel with the second arm and offset in the second direction from the second arm away from the bottom surface of the terminal channel to allow the fourth arm to deflect toward the second arm into a gap between the fourth arm and the second arm; wherein the third and fourth arms include mating portions that protrude into the first and second slots, respectively, and wherein the mating portion of the third arm and the mating portion of the first arm each comprise a contact portion protruding out of the corresponding terminal channel and extending beyond the at least one base surface by the same distance in the second direction, and the mating portion of the fourth arm and the mating portion of the second arm each comprise a contact portion protruding out of the corresponding terminal channel and extending beyond the at least one base surface by the same distance in the second direction.

Optionally, the first arm of each of the plurality of electrical terminals extends farther from the mounting portion than the third arm in the second direction such that the contact portions of the mating portions of both the third arm and the first arm are aligned and spaced apart in the first direction, and the second arm of each of the plurality of electrical terminals extends farther from the mounting portion than the fourth arm in the second direction such that the contact portions of the mating portions of both the fourth arm and the second arm are aligned and spaced apart in the first direction.

Optionally, the contact portions of the mating portions of the first, second, third and fourth arms of each of the plurality of electrical terminals are aligned in a first direction.

Optionally, the mating portions of the first and second arms of each of the plurality of electrical terminals each have a first inclined surface extending obliquely in a second direction from the respective contact portions to a free end of the respective arm in the first direction; and/or the mating portions of the third and fourth arms of each of the plurality of electrical terminals each have a second inclined surface extending obliquely in a second direction from the respective contact portions to a free end of the respective arm in the first direction.

Optionally, the gap between the third arm and the first arm of each of the plurality of electrical terminals extends to a location within the mounting portion which is aligned with the third arm in the first direction; and/or the gap between the fourth arm and the second arm of each of the plurality of electrical terminals extends to a location within the mounting portion which is aligned with the fourth arm in the first direction.

Optionally, the mounting portion of each of the plurality of electrical terminals includes a first surface configured to abut the bottom surface of the respective terminal channel, the first and second arms of each of the plurality of electrical terminals extending from or near the first surface of the mounting portion.

Optionally, roots of the third and fourth arms of each of the plurality of electrical terminals connected to the mounting portion are designed such that the roots are at or near surface portions of the at least one base surface, which are opposite to the first and second slots, in the second direction when the electrical terminal is mounted within the respective terminal channel.

Optionally, each of the first, second, third and fourth arms of each of the plurality of electrical terminals extends away from the mounting portion in the first direction or extends obliquely away from the first surface in the second direction while extending away from the mounting portion.

Optionally, the first surface of the mounting portion of each of the plurality of electrical terminals comprises at least one first protrusion protruding outwardly in a second direction, and the bottom surface of the corresponding terminal channel is formed with at least one first recess for receiving the at least one first protrusion.

Optionally, the mounting portion of each of the plurality of electrical terminals includes a pocket recessed from the first surface into the mounting portion, the at least one first protrusion protruding from a bottom surface of the pocket out of the first surface.

Optionally, the first protrusion of each of the plurality of electrical terminals has a protruding length in the second direction which is equal to or less than a depth of the corresponding first recess.

Optionally, the at least one first protrusion of each of the plurality of electrical terminals comprises two or more first protrusions spaced apart from each other in the first direction, and the at least one first recess comprises two or more first recesses arranged correspondingly.

Optionally, the at least one first protrusion of each of the plurality of electrical terminals has a varying cross section perpendicular to its protruding direction in at least a portion of its protruding length.

Optionally, the mounting portion of each of the plurality of electrical terminals comprises a second surface opposite to the first surface and at least two second protrusions protruding outwardly from the second surface and protruding out of the terminal channel, the at least two second protrusions spaced apart in the first direction.

Optionally, each of the plurality of electrical terminals comprises two second protrusions which protrude from the second surface in the second direction by a same distance.

Optionally, each of the plurality of electrical terminals further comprises at least one additional second protrusion between the two second protrusions, the at least one additional second protrusion protruding from the second surface in the second direction by a distance less than or equal to that of the two second protrusions.

Optionally, the at least one base surface comprises a platform protruding toward the inner surface, the first slot and the second slot are spaced apart by the platform in the first direction, and the at least two second protrusions protrude toward the inner surface from a channel segment of the terminal channel where the platform is located.

Optionally, the platform comprises a raised rib protruding outwardly between adjacent terminal channels and extending in a first direction, the rib and/or the second protrusion at a same level in the second direction.

Optionally, the electrical terminal is a stamped unitary piece.

Optionally, the connector housing includes a stop feature configured to be engaged with the platform to prevent further insertion of the terminal assembly when the terminal assembly is inserted into the housing cavity.

Optionally, the inner surface includes first and second surface sections corresponding to the first and second slots in the first direction and an intermediate surface section connecting the first and second surface sections, and the stop feature is: a flange protruding inwardly into the housing cavity between the first surface section and the intermediate section; or a stepped surface formed by the first surface section offset from the intermediate surface section toward the housing cavity.

Optionally, the connector housing includes a securing device for securing the electrical connector housing to an external component.

Optionally, the securing device includes a lug extending outwardly from an outer surface of the connector housing, the lug formed with a threaded hole.

Optionally, the securing device comprises a snap element attached to an outer surface of the connector housing, and the snap element is formed with a snap slot suitable for snapping the external component.

Optionally, the snap element includes one or more claws bounding the snap slot.

Optionally, the at least one base surface comprises only the first base surface.

Optionally, the at least one base surface includes both the first base surface and the second base surface, the plurality of terminal channels includes a first plurality of terminal channels formed in the first base surface and a second plurality of terminal channels formed in the second base surface, the plurality of electrical terminals includes a first plurality of electrical terminals corresponding to the first plurality of terminal channels and a second plurality of electrical terminals corresponding to the second plurality of terminal channels, and the inner surface includes a first inner surface and a second inner surface opposite to the first base surface and the second base surface, respectively; wherein the first and second plurality of terminal channels are arranged opposite to each other and the first and second plurality of electrical terminals are arranged opposite to each other, and wherein the first slot includes a first first slot bounded between the first base surface and the first inner surface and a second first slot bounded between the second base surface and the second inner surface, and the second slot includes a first second slot bounded between the first base surface and the first inner surface and a second second slot bounded between the second base surface and the second inner surface.

Optionally, the first plurality of electrical terminals and the second plurality of electrical terminals have the same structure.

Optionally, each of the first plurality of terminal channels is aligned with a corresponding one of the second plurality of terminal channels in the second direction; or each of the first plurality of terminal channels is offset from a corresponding one of the second plurality of terminal channels in the third direction.

Optionally, the connector housing includes a support portion disposed proximately to the first slot, and the support portion comprising a slit in communication with the first slot in the third direction and extending in the second direction.

Some embodiments relate to a connector assembly comprising: the electrical connector described as above; a first electrical device comprising a first electrical terminal assembly which, when inserted into the first slot, causes its electrical terminals to be electrically connected to the contact portions of the plurality of electrical terminals of the electrical connector that extend into the first slot; and a second electrical device comprising a second electrical terminal assembly which, when inserted into the second slot, causes its electrical terminals to be electrically connected to the contact portions of the plurality of electrical terminals of the electrical connector that extends into the second slot.

Optionally, the second electrical device further comprises a second device housing made of an insulating material and supporting the second electrical terminal assembly, both the second device housing and the second electrical terminal assembly partially inserted into the second slot.

Optionally, the first electrical device further comprises a first device housing made of an insulating material and supporting the first electrical terminal assembly, both the first device housing and the first electrical terminal assembly partially inserted into the first slot.

Optionally, each of the first and second electrical terminal assemblies is a flat cable terminal assembly comprising flat cable terminal(s) or a receptacle terminal assembly comprising receptacle electrical terminal(s).

Optionally, the connector housing of the electrical connector includes a support portion disposed adjacent to the first slot, the support portion comprising a slit in communication with the first slot in the third direction and extending in the second direction, and wherein the first electrical terminal assembly is partially inserted into the first slot through the slit.

Optionally, the first electrical terminal assembly is a flat cable terminal assembly comprising flat cable terminal(s), and the second electrical terminal assembly is a flat cable terminal assembly comprising flat cable terminal(s) or a receptacle terminal assembly comprising receptacle electrical terminal(s).

Optionally, the electrical terminal assembly comprising flat cable terminal(s) is an FFC or an FPC.

Some embodiments relate to an electrical connector comprising: a connector housing made of an insulating material and bounding a housing cavity extending through the connector housing in a first direction; and a terminal assembly disposed within the housing cavity, the terminal assembly comprising a base and a plurality of electrical terminals supported by the base, each of the plurality of electrical terminals comprising a retention portion and a pin portion and an arm portion which extend opposite to each other from the retention portion, the pin portion having a pin contact portion, and the arm portion comprising an arm contact portion, wherein the base has a first base surface and a second base surface opposite to each other in a second direction perpendicular to the first direction, at least one of the first base surface and the second base surface having a plurality of terminal channels extending into the base in the second direction, the plurality of terminal channels spaced apart in a third direction perpendicular to both the first direction and the second direction, wherein each of the plurality of electrical terminals is configured such that, when mounted within a respective terminal channel: an arm mating portion of the arm portion protrudes out of the terminal channel and into a slot between the at least one base surface and an opposing inner surface of the connector housing, and the pin portion protrudes out of the terminal channel in the first direction and is suspended within the housing cavity, wherein an initial void is formed between the arm portion of each of the plurality of electrical terminals and a bottom of the respective terminal channel that allows the arm portion to deflect toward the bottom of the terminal channel.

Optionally, the base includes a first portion and a second portion connected to each other in the first direction, a first surface portion of the at least one base surface provided by the first portion offset toward the inner surface of the connector housing in the second direction from a second surface portion of the first base surface provided by the second portion, the slot bounded between the second surface portion and the inner surface of the connector housing in the second direction.

Optionally, the retention portion of each of the plurality of electrical terminals is received within a channel segment of the respective terminal channel, which is within the first portion, the arm portion is received within a channel segment of the respective terminal channel which is within the second portion, and the pin portion protrudes out from the first portion in the first direction.

Optionally, the arm portion of each of the plurality of electrical terminals includes a first arm extending from the retention portion, the first arm having a first arm contact portion.

Optionally, the arm portion of each of the plurality of electrical terminals further comprises a second arm which extends from the retention portion in parallel with the first arm and which is offset from the first arm in the second direction away from the bottom of the respective terminal channel to form a gap between the second arm and the first arm.

Optionally, the second arm of each of the plurality of electrical terminals includes a second arm contact portion, the first and second arm contact portions aligned and spaced apart in the first direction and protruding out of the respective terminal channels by the same distance.

Optionally, the pin contact portion of each of the plurality of electrical terminals is a pin contacting surface extending in a plane defined by the first direction and the third direction.

Optionally, the pin portion of each of the plurality of electrical terminals has a tapered tip.

Optionally, each of the plurality of electrical terminals comprises a first terminal element and a second terminal element, the first terminal element comprising the arm portion and a first connecting portion, the second terminal element comprising the pin portion and a second connecting portion, and the first connecting portion and the second connecting portion connected together to form the retention portion.

Optionally, the first connecting portion and the second connecting portion are connected together by at least one of snapping, welding, riveting, and form-fitting.

Optionally, the first connecting portion includes two first legs extending opposite to the arm portion and spaced apart from each other, the two first legs comprising two first bulges protruding toward each other, the two first bulges each comprising an arm contact portion, the arm contact portions determining a minimum first spacing and configured for resiliently clamping on a second thickness of the second terminal element, and the first spacing less than the second thickness.

Optionally, the second connecting portion includes two second legs extending opposite to the pin portion and spaced apart from each other, the two second legs comprising two second bulges protruding toward each other, the two second bulges each comprising a pin contact portion, the pin contact portions determining a minimum second spacing and configured for resiliently clamping on a first thickness of the first terminal element, and the second spacing less than the first thickness.

Optionally, the arm contact portions of the two first bulges are aligned in the second direction.

Optionally, the pin contact portions of the two second bulges are offset from each other in the third direction.

Optionally, the first terminal element is a plate having the first thickness and the second terminal element is a plate having the second thickness.

Optionally, the first thickness is less than the second thickness.

Optionally, the first thickness is about 0.2 mm.

Optionally, the second thickness is 0.4-0.5 mm.

Optionally, the first terminal element of the electrical terminal and the base of the terminal assembly include features that interfere with each other when the electrical terminal is inserted into the corresponding terminal channel.

Optionally, one of the first terminal element and the base of the terminal assembly includes a limiting block and the other includes a limiting recess adapted to receive the limiting block.

Optionally, the base has an end surface, the pin portion extends out of the terminal channel at the end surface, and the end surface comprises a bulge located between adjacent electrical terminals in the third direction.

Optionally, the connector housing comprises a lug with a threaded hole; and/or comprises a snap element having a snap slot for snapping to an external component.

Some embodiments relate to a connector assembly comprising: the electrical connector described above; a first electrical device comprising a first electrical terminal assembly, the first electrical terminal assembly configured to be inserted into the slot to be electrically connected with the arm contact portions of the plurality of electrical terminals of the electrical connector; and a second electrical device comprising a second electrical terminal assembly, the second electrical terminal assembly comprising receptacle electrical terminals, and the second electrical terminal assembly adapted to be inserted into the housing cavity to be electrically connected with the pin portions of the plurality of electrical terminals of the electrical connector.

Optionally, the first electrical terminal assembly of the first electrical device is an FFC or an FPC.

Optionally, the receptacle electrical terminal is a crimp terminal for a cable.

Optionally, the second electrical device further comprises a cable connected to crimp terminals.

Optionally, the first electrical device comprises a first device housing supporting the first electrical terminal assembly, the first device housing comprising a resilient snap structure and the connector housing comprising a hook portion configured to be snapped with the resilient snap structure.

Optionally, the first electrical device further comprises a CPA member configured to lock the resilient snap structure and the hook portion in an engaged state.

These techniques may be used alone or in any suitable combination. The foregoing summaries are provided by way of illustration and are not intended to be limiting.

### BRIEF DESCRIPTION OF THE DRAWINGS

The accompanying drawings are not intended to be drawn to scale. In the drawings, identical or nearly identical components that are illustrated in various figures may be represented by a like numeral. For purposes of clarity, not every component may be labeled in every drawing. In the drawings:

FIG. 1 is a partially exploded perspective view of an electrical connector comprising a connector housing and a terminal assembly, according to some embodiments.

FIG. 2 is an enlarged view of a portion of the terminal assembly of the electrical connector of FIG. 1.

FIG. 3 is a perspective view of electrical terminals of the terminal assembly of the electrical connector of FIG. 1.

FIG. 4 is a perspective view of a base of the terminal assembly of the electrical connector of FIG. 1.

FIG. 5 is a perspective view of one of the electrical terminals.

FIG. 6 is a cross-sectional view of a connector assembly comprising the electrical connector of FIG. 1.

FIG. 7 is an exploded view of an electrical connector, according to some embodiments.

FIG. 8 is a side view of the electrical connector of FIG. 7.

FIG. 9 is a cross-sectional view of a connector assembly, according to some embodiments.

FIG. 10 is an assembly view of an electrical connector, according to some embodiments.

FIG. 11 is another schematic view of the electrical connector of FIG. 10.

FIG. 12 is a perspective view of the electrical connector of FIG. 10, with a connector housing and a terminal assembly separated from each other.

FIG. 13 is a perspective view of an electrical terminal of the electrical connector of FIG. 10.

FIG. 14 is a perspective view of a first terminal element of the electrical terminal of FIG. 13.

FIG. 15 is a perspective view of a second terminal element of the electrical terminal of FIG. 13.

FIG. 16 is a perspective view of a limiting block and a limiting recess of the electrical connector in FIG. 10.

FIG. 17 is an enlarged view of a region within a circle marked “A” in FIG. 16.

FIG. 18 illustrates a spacer block formed on a base of the electrical connector of FIG. 10.

FIG. 19 is an enlarged view of a region within a circle marked “B” in FIG. 18.

FIG. 20 shows an example of a securing device that can be included in a connector housing of an electrical connector of this application.

FIG. 21 shows another example of a securing device that can be included in a connector housing of an electrical connector of the present application.

FIG. 22 is a schematic structural view of a connector assembly, according to some embodiments.

FIG. 23 is a partially exploded perspective view of a first electrical device of the connector assembly of FIG. 22.

FIG. 24 is a partially exploded perspective view of a second electrical device of the connector assembly of FIG. 22.

FIG. 25 is a perspective view of a resilient snap structure on a first device housing of a first electrical device of a connector assembly and a connector position assurance (CPA) member.

FIG. 26 is a cross-sectional view showing an interaction of the resilient snap structure, the hook portion and the CPA member.

### DETAILED DESCRIPTION

The inventors have recognized and appreciated techniques for making versatile electrical connectors for use in a harsh environment such as one presented by an automobile. For example, the connector may be used to connect a battery management system (BMS) and cell sensing circuit (CSC) in automobiles. The connector may be compatible with related standards such as USCAR-2 and TC9.

The inventors have recognized and appreciated that, in systems such as communication systems, data storage systems, data transmission systems, or battery management systems (e.g., for new energy vehicles), multiple electrical connectors are commonly used to electrically connect two electrical devices of the same type or of different types, as well as to connect other electrical devices (such as printed circuit boards, PCBs) that are electrically connected to the respective devices. For example, two flexible printed cables (FPCs) may be electrically connected by FPC/FPC electrical connectors, two flexible flat cables (FFCs) may be electrically connected by FFC/FFC electrical connectors, and a flexible printed circuit and a flexible flat cable may be electrically connected with a board connector and an FPC/FFC electrical connector.

According to aspects of the present disclosure, a single electrical connector may provide reliable interconnections between various types of electrical devices (e.g., flexible cables and/or twinax cables) in a harsh environment such as one presented by an automobile. In some embodiments, an electrical connector may include a housing having a cavity, and a terminal assembly disposed in the cavity. The terminal assembly may include a base separating the cavity into first and second slots each configured to receive an electrical device, and terminals each having a mounting portion fixedly held by the base and arms extending in opposite directions from the mounting portion and movable relative to the base. For each terminal, at least one arm includes a mating portion protruding into the first slot to contact a first electrical device inserted therein, and at least one arm includes another mating portion protruding into the second slot to contact a second electrical device inserted therein.

According to aspects of the present disclosure, an electrical connector and a connector assembly comprising the electrical connector is provided. An electrical terminal of the electrical connector includes at least a first contact portion protruding into a first slot for electrically connecting a first electrical device and a second contact portion protruding into a second slot for electrically connecting a second electrical device in the same direction. The two slots of the electrical connector can be connected with electrical devices of the same type or of different types.

According to aspects of the present disclosure, an electrical connector can be used to electrically connect electrical devices including the same or different types of electrical terminal assemblies. The electrical terminal assembly of the electrical device may be an electrical terminal assembly including flat cable terminal(s) or an electrical terminal assembly including receptacle terminal(s). The flat cable terminal may be a terminal of a relatively flexible FPC or FFC or a relatively rigid board-to-board terminal. The receptacle terminal may be a crimp terminal for a cable. Accordingly, the electrical connector is capable of electrically connecting flat cable terminal assemblies to one another, or electrically connecting a flat cable terminal assembly with a cable terminal assembly (e.g., a receptacle terminal assembly), thereby providing high universality and suitability for use in battery management systems and other electronic device assemblies.

According to aspects of the present disclosure, the double-elastic-arm structure of each of the electrical terminals provides a double-contact-portion (or double-contact-point) electrical connection with a corresponding electrical terminal of an inserted external electrical device. This configuration enhances the stability and reliability of the electrical connection and can effectively reduce the risk of transient disconnection. The electrical connection achieved by the double-contacting-portion structure is capable of meeting the power supply requirements of large current and multiple pins.

In some embodiments, the two elastic arms of the electrical terminal of the electrical connector adopt a long-cantilever structure, thereby enabling a relatively large elastic contact force to be generated within in a limited space and ensuring that forces applied to the arms are highly consistent. This configuration enhances the durability of the electrical connector as well as the reliability and stability of the electrical connection. Each contact of the electrical terminal has an inclined guide structure configured to guide insertion and engagement with a corresponding electrical terminal of the external electrical device. This inclined guide structure facilitates smoother insertion and engagement, reduces the risk of pin retraction, and avoids the need for excessive insertion force.

In some embodiments, the electrical connector includes two rows of electrical terminals, thereby accommodating applications requiring a large number of pins. The two rows of electrical terminals may be arranged in a staggered configuration, which may reduce the overall size, especially the height, of the electrical connector and conserves the occupied space.

The inventors have recognized and appreciated that electrical connectors are used in electronic systems for connecting two electrical devices. An electrical device that is mechanically and electrically connectable to the electrical connector of the present application may may be referred to herein as an “external electrical device.” For example, the electrical device may be, but is not limited to, another electrical connector. The electrical connector connects the two electrical devices together to form a connector assembly.

The inventors have further recognized and appreciated that it is desirable for the electrical connector and the connector assembly to exhibit characteristics that satisfy the mechanical and electrical requirements of electronic systems. For example, it is desirable for the electrical connector and the connector assembly to provide high safety and reliability, including sufficiently high dielectric withstand voltage performance. It is also desirable for the electrical connector and the connector assembly to have a reduced footprint in the electronic system. In addition, it is desirable for the electrical connector to support hot-swap functionalities, and for the connector assembly to allow for convenient assembly and/or disassembly in a space-constrained environment.

The inventors have recognized and appreciated design techniques for the electrical connector that achieve such mechanical and electrical characteristics. Such techniques may enable electrical connectors and connector assemblies that are highly reliable, easy to assemble and maintain, and capable of reliable mating with another electrical connector, while satisfying mechanical requirements specified by standards such as USCAR.

According to aspects of the present disclosure, an electrical connector is configured to connect two electrical devices of the same or different types to transfer power and/or signals therebetween. An electrical device connected to cooperate with the electrical connector of the present application is described as including an electrical terminal assembly, which may include: a flat cable terminal assembly including flat cable terminal(s), or a receptacle terminal assembly including receptacle terminal(s).

In the present application, the term “flat cable terminal” may refer to an electrically conductive member having a flat-shaped connecting end. In some embodiments, the flat cable terminal may be a relatively flexible conductive terminal. Accordingly, the flat cable terminal assembly may include a flexible printed circuit (FPC) or a flexible flat cable (FFC). In some embodiments, the flat cable terminal may be a relatively rigid conductive terminal, such as a board-to-board or board-end terminal. Accordingly, the flat cable terminal assembly may include a board-to-board connector.

In the present application, the term “receptacle terminal” may include a cable terminal configured for connection to a cable, such as, but not limited to, a crimp terminal, or any other suitable form of a receptacle terminal. Accordingly, the receptacle terminal assembly of the present application includes, but is not limited to, a cable terminal assembly including cable terminals.

Accordingly, an electrical connector of the present disclosure is capable of achieving at least: an electrical connection between a first electrical device (e.g., a flat cable connector) including a flat cable terminal assembly and a second electrical device (e.g., another flat cable connector) including a flat cable terminal assembly, or an electrical connection between a first electrical device (e.g., a flat cable connector) including a flat cable terminal assembly and a second electrical device (e.g., a receptacle connector) including a receptacle terminal assembly. As such, the electrical connector of the present application exhibits high versatility and is applicable to battery management systems and other electronic device assembly fields.

Some embodiments of this application are described in detail below with reference to the accompanying drawings. It should be understood that these examples are not intended to limit the present disclosure. In addition, features in the embodiments of this application may be combined with each other without conflict.

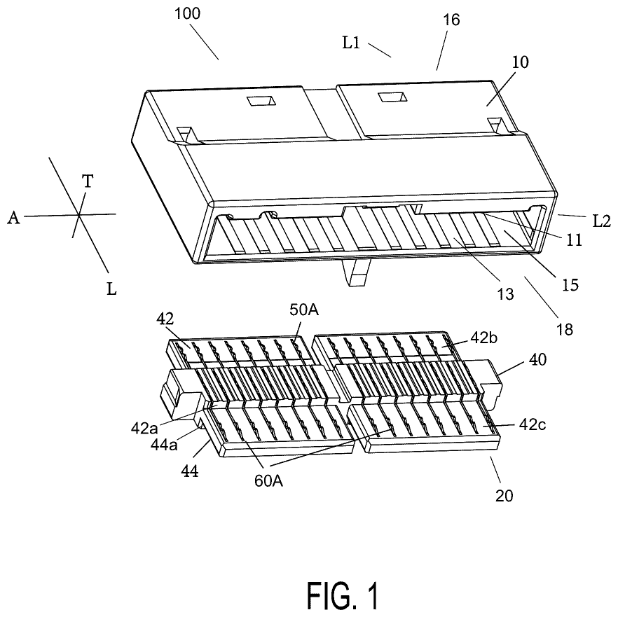

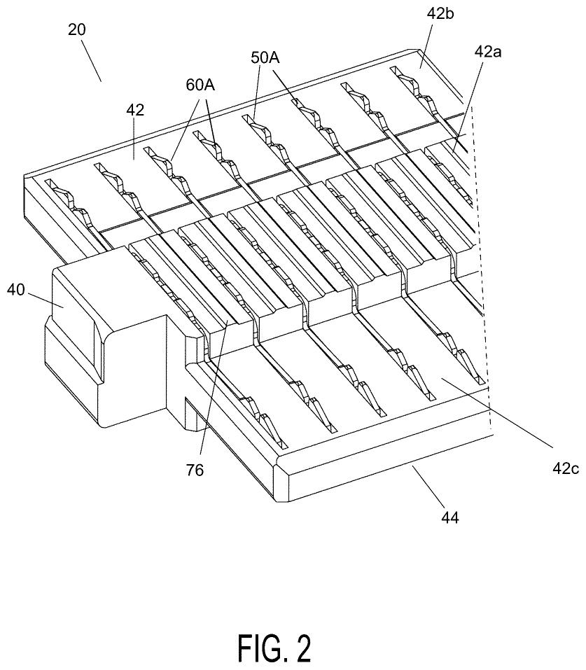

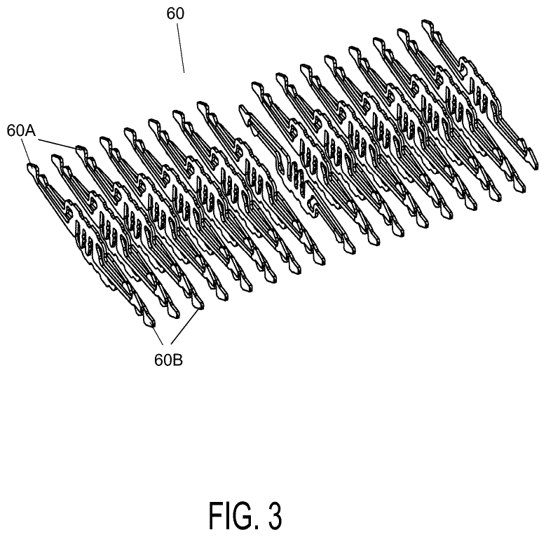

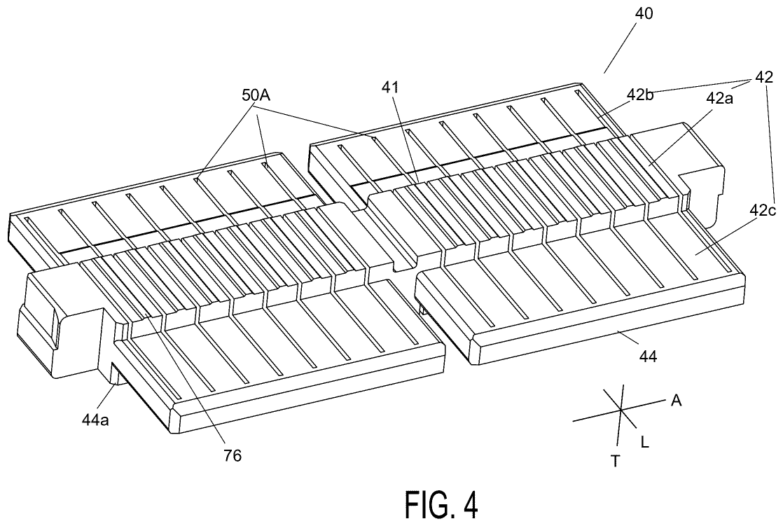

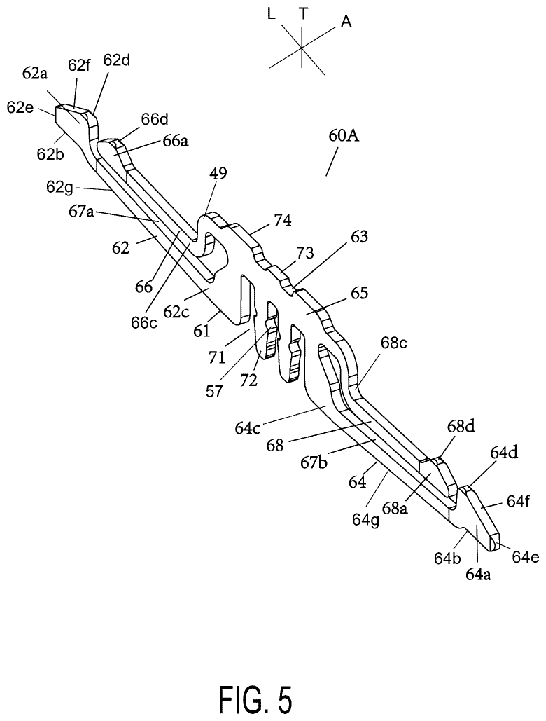

Referring first to FIGS. 1-6, an electrical connector 100 is shown. The electrical connector 100 may include a connector housing 10 made of an insulating material (e.g., plastic) and a terminal assembly 20 housed within the connector housing 10. The terminal assembly 20 may include a base 40 and a plurality of electrical terminals 60 supported by the base 40. FIG. 1 shows a view of the connector housing 10 separated from the terminal assembly 20; FIG. 2 shows an enlarged partial view of the terminal assembly 20; FIG. 3 is a view of the plurality of electrical terminals 60 of the terminal assembly 20; FIG. 4 is a view of the base 30 of the terminal assembly 20; and FIG. 5 shows one of the electrical terminals 60.

As shown in FIG. 1, the connector housing 10 defines a housing cavity 15, and the housing cavity 15 extends through the connector housing 10 along a first direction L. The terminal assembly 20 can be inserted or assembled into the housing cavity 15 along the first direction L to form a first mating port 16 and a second mating port 18 on opposite sides (a first side L1 and a second side L2) of the electrical connector 100 in the first direction L, and the first mating port 16 and the second mating port 18 are configured to connect a first electrical device and a second electrical device, respectively. The connector housing 10 can serve as a support frame for the terminal assembly 20. In a second direction T perpendicular to the first direction L, the housing cavity 15 is bounded by opposing first and second inner surfaces 11, 13 of the connector housing 10.

The base 40 of the terminal assembly 20 has a first base surface 42 and a second base surface 44 opposite in the second direction T. The first base surface 42 and the second base surface 44 each extend parallel to a plane defined by the first direction L and a third direction A perpendicular to both the first direction L and the second direction T.

The base 40 includes a first platform 42a extending outwardly from the first base surface 42 generally in the second direction T, the first platform 42a protruding generally from a middle portion of the first base surface 42 in the first direction L, thereby dividing the first base surface 42 into a first surface portion 42b on the first side L1 of the first platform 42a and a second surface portion 42c (FIG. 2) on the second side L2 of the first platform 42a.

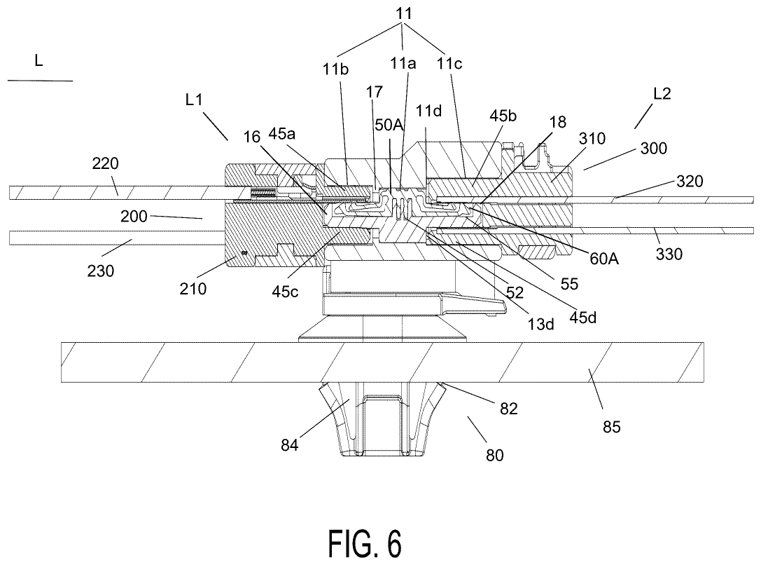

In the first direction L, the first inner surface 11 of the connector housing 10 includes a first surface section 11b, a second surface section 11a, and a third surface section 11c (FIG. 6) respectively corresponding to the first surface portion 42b, the first platform 42a and the second surface portion 42c of the first base surface 42 of the base 40 inserted therein. Thus, with the terminal assembly 20 inserted into the housing cavity 15, a first slot 45a (FIG. 6) is bounded between the first surface portion 42b of the first base surface 42 of the base 40 and the first surface section 11b of the first inner surface 11 of the connector housing 10, and a second slot 45b (FIG. 6) is bounded between the second surface portion 42c of the first base surface 42 of the base 40 and the third surface section 11c of the first inner surface 11 of the connector housing 10. In the first direction L, the first slot 45a and the second slot 45b are spaced apart by the first platform 42a of the base 40 of the terminal assembly 20. The first and second slots 45a, 45b are configured to receive an insertion portion of the first electrical device and an insertion portion of the second electrical device, respectively, when the first and second electrical devices are connected to the first and second mating ports 16, 18, respectively, such that electrical terminals of the first electrical device inserted into the first slot 45a are placed in electrical communication with electrical terminals of the second electrical device inserted into the second slot 45b by the electrical terminals of the terminal assembly 20.

Dimensions of the first slot 45a and the second slot 45b in the second direction may be designed as required. In some embodiments, the first slot 45a may be configured to receive a portion of a first device housing of the first electrical device such that the electrical terminals supported by the portion are exposed within the first slot 45a and electrically connected to the electrical terminals of the terminal assembly 20 of the electrical connector 100 (FIG. 6). In this case, a size of the first slot 45a in the second direction may be relatively large.

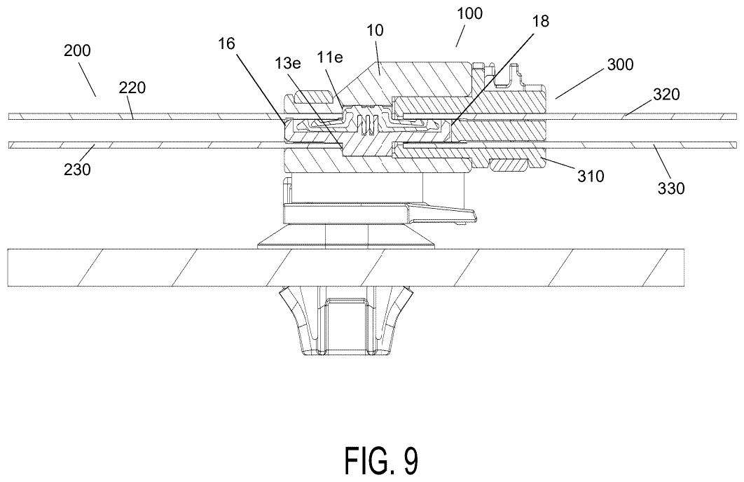

In some other embodiments, the first slot 45a may be configured to directly receive a portion of an electrical terminal assembly of the first electrical device such that it is partially exposed within the first slot 45a and electrically connected to the electrical terminals of the terminal assembly 20 of the electrical connector 100 (FIG. 9). In this case, the first slot 45 a may be sized to be relatively small correspondingly.

It can be seen from a cross-sectional view of FIG. 6 that the first surface section 11b of the first inner surface 11 of the connector housing 10 is substantially flush with the second surface section 11a which corresponds to the first platform 42a of the first base surface 42 of the base 40 in the first direction L. Optionally, the first surface section 11b is slightly farther from the first base surface 42 of the base 40 in the second direction T than the second surface section 11a. The third surface section 11c of the connector housing 10 is disposed farther away from the first base surface 42 of the base 40 in the second direction T than the intermediate second surface section 11a.

The first inner surface 11 of the connector housing 10 includes a flange 17 protruding (e.g., in the second direction T) into the housing cavity 15 between the first surface section 11b and the second surface section 11a. The flange 17 protrudes from the first inner surface 11 by a distance so as to interfere with a corresponding feature of the terminal assembly 20 when the terminal assembly 20 is inserted into the housing cavity 15 in the first direction L from the second side L2 via the second mating port 18, to indicate to an operator that the terminal assembly 20 has been inserted into place and to prevent the terminal assembly 20 from over-insertion.

As illustrated, the corresponding feature of the terminal assembly 20 may be the first platform 42a on the first base surface 42 of the base 40. In some embodiments, the corresponding feature may be the mounting portion 65 (see FIG. 5) of the electrical terminals 60A of the terminal assembly 20, or both. Additionally or alternatively, the corresponding feature of the terminal assembly 20 may also be any other structure capable of interfering with the flange 17 and provided by the base 40 and/or any one or more of the electrical terminals 60A. In some embodiments, the flange 17 may extend across the entire extent of the housing cavity 15 in the third direction A, or may extend across a portion or some discrete portions of the extent.

In some embodiments, if the relative dimensions of the first surface section 11b and the second surface section 11a in the second direction T are configured such that the terminal assembly 20 can be inserted into the housing cavity 15 from the first side L1 via the first mating port 16, the flange 17 for the above stopping function may be provided between the second surface section 11a and the third surface section 11c.

Similar to the first inner surface 11 including three sections 11b, 11a, and 11c corresponding to the three portions 42b, 42a, and 42c of the first base surface 42 of the base 40, the housing cavity 15 may sometimes be described as including three corresponding cavity sections for ease of description.

Referring back to FIGS. 1-5, the base 40 of the electrical connector 100 includes a plurality of terminal channels 50A extending from the first base surface 42 into an interior of the base 40 in the second direction T, the plurality of terminal channels 50A spaced apart in the third direction A forming a row, and each terminal channel 50A configured to accommodate or receive one electrical terminal 60A. Each terminal channel 50A is elongated in the first direction L, extends across the entire first platform 42a and extends from the first platform 42a toward the first side L1 and the second side L2, and terminates within portions of the base 40 corresponding to the first slot 45a and the second slot 45b. Opposite ends of each terminal channel 50A in the first direction L are located in the portions of the base 40 corresponding to the first slot 45a and the second slot 45b. Each terminal channel 50A does not penetrate through the base 40 in the first direction L. In the second direction, the terminal channel 50A also terminates within the base 40 and has a bottom surface 55 (FIG. 6).

The electrical terminal 60A, when received in the terminal channel 50A or inserted into the terminal channel 50A in the second direction T, has at least one mating portion protruding (in the second direction T) out of the terminal channel 50A and into the first slot 45a for electrical contact and electrical connection with the electrical terminals of the inserted first electrical device, and has at least one mating portion protruding out of the terminal channel 50A and into the second slot 45b for electrical contact and electrical connection with the electrical terminals of the inserted second electrical device.

A view of the electrical terminal 60A is shown in FIG. 5. In this embodiment, the electrical terminal 60A may be made of a conductive material, such as metal, and may take the form of, but is not limited to, an integral piece. The electrical terminal 60A is generally in the form of a plate and thus may be manufactured by stamping and any process known in the art.

After assembled into the terminal channel 50A of the base 40 and inserted into the housing cavity 15, the electrical terminal 60A extends within an extension plane defined by the first direction L and the second direction T.

The electrical terminal 60A includes a mounting portion 65 for retaining the electrical terminal 60A within the terminal channel 50A, the mounting portion 65 including a first surface 61 configured to abut or contact the bottom surface 55 (FIG. 6) of the terminal channel 50A when the electrical terminal 60A is mounted within the respective terminal channel 50A and a second surface 63 opposite to the first surface 61 in the second direction T.

The electrical terminal 60A further includes a first arm 62 and a second arm 64 extending from the mounting portion 65 (from opposite ends or sides in the first direction L) toward the first side L1 and the second side L2, respectively. The first and second arms 62 and 64 include mating portions 62a and 64a, respectively, that protrude away from the first surface 61 of the mounting portion 65 (and thus away from the bottom surface 55 of the terminal channel 50A) in the second direction T, so as to protrude out of the terminal channel 50A into the corresponding slot after the electrical terminal 60A is mounted into the terminal channel 50A.

The first and second arms 62, 64 are configured such that the first and second arms 62, 64 form an initial void from the bottom surface 55 of the terminal channel 50A after the electrical terminal 60A is mounted in the respective terminal channel 50A and before it is connected with an external electrical device. The initial void allows the first arm 62 and the second arm 64 to deflect towards the bottom surface 55 of the terminal channel 50A under an external force and return to their original positions as the external force disappears, the deflection being, for example, rotation around roots 62c and 64c (FIG. 5) of the respective arms connected to the mounting portion 65. For example, the external force is caused by the electrical terminals of the first and second electrical devices electrically contacting and pushing against the mating portions 62a and 64a of the first and second arms 62 and 64 of the electrical terminal 60A during insertion of the insertion portions of the first and second electrical devices into the first and second slots 45a and 45b.

The provision of the initial void may be achieved in a variety of forms. In the illustrated embodiment, the first arm 62 and the second arm 64 each extend from the first surface 61 of the mounting portion 65, and extend away from the bottom surface 55 of the terminal channel 50A or toward the second surface 63 of the mounting portion 65 in the second direction T while extending away from the mounting portion 65 in the first direction L, and the formed initial void may become larger as it is farther away from the mounting portion 65.

Optionally, in some embodiments, the first arm 62 and the second arm 64 may extend from the mounting portion 65 at a position offset from the first surface 61, and the first arm 62 and the second arm 64 do not have to extend obliquely.

The mating portions 62a of the first arms 62 of the electrical terminals 60A of the terminal assembly 20 extend out of the terminal channel 50A in the second direction T (in an initial state without the external force) and extend into the first slot 45a. The mating portions 62a of the first arms 62 of the electrical terminals 60A extend out of the terminal channel 50A by substantially the same distance, or extend beyond the first base surface 42 (the first surface portion 42b) of the base 40 by substantially the same distance, or have contact portions 62d which are aligned in a plane perpendicular to the second direction T, to ensure that the electrical terminals 60A are well electrically connected to the electrical terminals of the first electrical device which is inserted into the first slot 45a. The “contact portion” of the arms may have any form, for example, a curved surface such as an illustrated convex surface. Any other structural details (e.g., shape, cross-section, tilt direction, curved curvature, etc.) of the contact portion that are beneficial to improve electrical connection reliability and stability are within the scope of the present application.

Similarly, the mating portions 64a of the second arms 64 of the electrical terminals 60A of the terminal assembly 20 extend out of the terminal channel 50A by substantially the same distance, or extend beyond the first base surface 42 (the second surface portion 42 c) of the base 40 by substantially the same distance, or have contact portions 64d which are aligned in a plane perpendicular to the second direction T, to ensure that the electrical terminals 60A are well electrically connected to the electrical terminals of the second electrical device which is inserted into the second slot 45a.

For the first and second arms 62 and 64, the mating portions 62a and 64a each further includes a first inclined surface 62f and 64f extending obliquely from the respective contact portions 62d and 64d to free ends 62e and 64e of the respective arms in the first direction. The first inclined surfaces 62f and 64f are configured to guide or facilitate insertion of the insertion portions of the first and second electrical devices into the first and second slots 45a and 45b, respectively.

As illustrated, the electrical terminal 60A further includes a third arm 66 which extends from the mounting portion 65 in the first direction L in the same direction as the first arm 62 (toward the first side L1) and a fourth arm 68 which extends from the mounting portion 65 in the first direction L in the same direction as the second arm 64 (toward the second side L2). Similar to the first and second arms 62 and 64, the third and fourth arms 66 and 68 are formed with mating portions 66a and 68a, respectively, which extend away (in the second direction T) from the first and second arms 62 and 64, away from the bottom surface 55 of the terminal channel 50A, and into the first and second slots 45a and 45b, and the mating portions have contact portions 66d and 68d which are closest to the first inner surface 11 of the connector housing 10 to directly electrically contact the electrical terminals of the first and second electrical devices.

The third arm 66 is spaced from the first arm 62 in the second direction T and is offset from the first arm 62 away from the bottom surface 55 of the terminal channel 50A, to form a gap 67a between the third arm 66 and the first arm 62 that allows the third arm 66 to deflect into the gap toward the first arm 62 (and thus toward the bottom surface 55 of the terminal channel 50A). In the second direction T, the first arm 62 is closer to the bottom surface 55 of the terminal channel 50A than the third arm 66. The gap 67a allows any one of the third arm 66 and the first arm 62 to freely deflect relative to the other. For example, during insertion of the insertion portion of the external device into the corresponding slot, the electrical terminal of the external device contacts and pushes against the contact portion 62d of the first arm 62 firstly, and the first arm 62 deflects relative to the third arm 66 toward the bottom surface 55 of the terminal channel 50A before the electrical terminal of the external device contacts the contact portion 66d of the third arm 66. As the external device is further inserted, when the electrical terminal of the external device contacts the contact portion 66d of the third arm 66, the third arm 66 begins to deflect relative to the first arm 62 toward the first arm 62.

Both the first arm 62 and the third arm 66 extend in the same direction from the mounting portion 65 in the first direction L, the first arm 62 extends beyond the third arm 66 such that (the contact portion 62d of) the mating portion 62a of the first arm 62 is spaced apart from and aligned (in a line) with (the contact portion 66d of) the mating portion 66a of the third arm 66 in the first direction L, with the former farther away from the mounting portion 65 than the latter. In some embodiments, the contact portion 62d of the mating portion 62a of the first arm 62 and the contact portion 66d of the mating portion 66a of the third arm 66 that protrude into the first slot 45a may protrude out of the terminal channel 50A (or beyond the first base surface 42 of the base 40) by the same distance, or may be equidistant from (the first surface section 11b of) the opposing first inner surface 11 of the connector housing 10 so as to simultaneously make electrical contact with the electrical terminal of the first electrical terminal assembly of the inserted first electrical device.

Similarly, the fourth arm 68 is spaced from the second arm 64 in the second direction T and is offset from the second arm 64 away from the bottom surface 55 of the terminal channel 50A, to form a gap 67b between the fourth arm 68 and the second arm 64 that allows the fourth arm 68 to deflect into the gap 67b toward the second arm 64, and thus toward the bottom surface 55 of the terminal channel 50A. In the second direction T, the second arm 64 is closer to the bottom surface 55 of the terminal channel 50A than the fourth arm 68. The gap 67b allows any one of the fourth arm 68 and the second arm 64 to freely deflect relative to the other.

Both the second arm 64 and the fourth arm 68 extend in the same direction from the mounting portion 65 in the first direction L, and the second arm 64 extends beyond the fourth arm 68 such that (the contact portion 64d of) the mating portion 64a of the second arm 64 is spaced apart from and aligned (in a line) with (the contact portion 68d of) the mating portion 68a of the fourth arm 68 in the first direction L, with the former farther from the mounting portion 65 than the latter. In some embodiments, the contact portion 64d of the mating portion 64a of the second arm 64 and the contact portion 68d of the mating portion 68a of the fourth arm 68 that protrude into the second slot 45b may protrude out of the terminal channel 50A (or beyond the first base surface 42 of the base 40) by the same distance, or may be equidistant from (the third surface section 11c of) the opposing first inner surface 11 of the connector housing 10, so as to simultaneously make electrical contact with the electrical terminal of the first electrical terminal assembly of the inserted second electrical device.

With the foregoing functions implemented, the gap 67a and the gap 67b may have any suitable size. For example, as shown in FIG. 5, the surfaces 62b and 64b of the mating portions 62a and 64a of the first and second arms 62 and 64 each are offset from arm surfaces 62g and 64g away from the bottom surface 55 of the terminal channel.

As shown in FIG. 5, the first arm 62 and the third arm 66 extend substantially parallel to each other, both of which are inclined toward the outside (the first slot 45a) of the terminal channel 50A as they extend away from the mounting portion 65, so that the size of the gap 67a can remain unchanged as the arms extends away from the mounting portion 65. However, this is not necessary. As mentioned above, both the first arm 62 and the third arm 66 may extend substantially along the first direction L without being inclined in the second direction T, and the same function can be achieved as long as the respective mating portions 62a and 66a protrude in the second direction T by an appropriate distance. As another example, in some embodiments, the first arm 62 and the third arm 66 are slightly inclined toward or away from each other as they extend away from the mounting portion 65, so that the size of the gap 67a gradually increases.

The first arm 62 and the third arm 66 include the roots 62c and 66c, respectively, which are connected to the mounting portion 65, and the gap 67a extends between the roots 62c and 66c and toward the mounting portion 65, into the mounting portion 65, then obliquely toward the second surface 63 of the mounting portion 65, and to a position within the mounting portion 65 that is substantially aligned with the root 64c in the first direction L or to a position even closer to the second surface 63. The gap 67a extending into the mounting portion 65 provides the third arm 66 and the first arm 62 with increased resiliency.

For the gap 67b between the second arm 64 and the fourth arm 68, similarly, the second arm 64 and the fourth arm 68 may extend substantially in parallel or obliquely away from each other as they extend away from the mounting portion 65 to form a gap 67b with a proper size. The gap 67b may extend between roots 64c and 68c of the second and fourth arms 64 and 68 connected to the mounting portion 65 and toward the mounting portion 65, into the mounting portion 65, then obliquely toward the second surface 63 of the mounting portion 65, and to a position within the mounting portion 65 which is substantially aligned with a root 68c of the fourth arm 68 in the first direction L or to a position which is even closer to the second surface 63.

As electrical terminal 60A includes the two arms which extend in the same direction from the mounting portion 65 toward the first side L1 and provides the two mating portions (62a and 66a) and the two contact portions (62d and 66d) which extend into the first slot 45a and aligned and spaced apart in the first direction L, when the first electrical device is attached to the first mating port 16 of the electrical connector 100, the electrical terminals of the first electrical device will gradually electrically contact and electrically connect the two mating portions (62a and 66a) or the two contact portions (62d and 66d) of each electrical terminal 60A. It is the same on the second side L2. The fact that the electrical terminal 60A provides two mating portions (64a and 68a) and two contact portions (64d and 68d) that extend into the second slots 45b are aligned and spaced apart in the first direction L results in that: the electrical terminals of the second electrical device will gradually electrically contact and electrically connect the two mating portions (64a and 68a) or the two contact portions (64d and 68d) of each electrical terminal 60A when the second electrical device is attached to the second mating port 18 of the electrical connector 100.

On either side in the first direction L where the electrical terminal 60A is to be electrically connected to the first electrical device and the second electrical device, respectively, the electrical terminal 60A is constructed to include two arms (62 and 66, 64 and 68) and two mating portions (62a and 66a, 64a and 68a), which can meet the requirements of high current and multi-pin (PIN).

It should be understood by those skilled in the art that although the electrical connector 100 of the present application is constructed to include two arms (or two elastic arms) and two mating portions (or two contact portions) on either side, it is not limited thereto. In some embodiments, a structure may include three or more arms, corresponding to three or more mating portions.

Aspects of the electrical terminal 60A related to the electrical connection function has been described as above, and other aspects of the electrical terminal 60A will be described below in conjunction with FIGS. 2, 5, and 6.

The mounting portion 65 of the electrical terminal 60A is seated in a channel segment of the terminal channel 50A corresponding to the first platform 42a when the electrical terminal 60A is mounted within the terminal channel 50A. Referring to FIG. 5 and FIG. 6, the extent or size of the mounting portion 65 of the electrical terminal 60A in the first direction L is substantially equal to or slightly smaller than that of the first platform 42a of the base 40 (or that of the channel segment of the terminal channel 50A corresponding to the first platform 42a) in the first direction L. In some embodiments, the second surface 63 of the mounting portion 65 of the electrical terminal 60A is formed with rounded corners 49 at two edges in the first direction L. In this way, (the second surface 63 of) the mounting portion 65 of the electrical terminal 60A does not protrude, in the first direction L, out of the channel segment of the terminal channel 50A corresponding to the first platform 42a.

In this manner, when the electrical connector 100 is inserted into the housing cavity 15 in the first direction L from the second mating port 18 and reaches its expected position, it is an edge 41 (FIG. 4) of the first platform 42a of the base 40, rather than a portion of the electrical terminal 60A itself, that engages the flange 17 on the first inner surface 11 of the connector housing 10, and thus the first platform 42a of the base 40 serves as the stop feature that engages the flange 17. This helps to protect the electrical terminal 60A and ensure the electrical connection characteristics of the electrical terminal 60A.

In the second direction T, the extent or size of the mounting portion 65 of the electrical terminal 60A (e.g., determined by the first surface 61 and the second surface 63) is slightly smaller than that of the channel segment of the terminal channel 50A corresponding to the first platform 42a in the second direction T, i.e., the depth of the channel segment, so that the second surface 63 of the mounting portion 65 of the electrical terminal 60A does not protrude out of the terminal channel 50A.

Referring to FIG. 5, the first surface 61 of the mounting portion 65 of the electrical terminal 60A, as a surface that contacts the bottom surface 55 of the terminal channel 50A when the electrical terminal 60A is inserted into the terminal channel 50A, includes a first protrusion 72 that protrudes outwardly in the second direction T. Accordingly, the bottom surface 55 of the terminal channel 50A is formed with a recess 52 (FIG. 6) for receiving the first protrusion 72. During the insertion of the electrical terminal 60A, the engagement of the first protrusion 72 of the electrical terminal 60A with the recess 52 of the terminal channel 50A can prompt the operator that the electrical terminal 60A is at an accurate position relative to the terminal channel 50A in the first direction L, which can play a guiding role during the subsequent insertion of the electrical terminal 60A and provide an effect of preventing the electrical terminal 60A from being displaced in the first direction L within the terminal channel 50A. In this aspect, it is possible to provide one first protrusion 72 and one corresponding recess 52. Two (as shown in the illustrated embodiment) or more first protrusions 72 may be provided, which can not only provide a good guiding effect, but also enhance the stability of the electrical terminal 60A in the terminal channel 50A and improve the durability of the electrical connector. Furthermore, this facilitates to prevent possible rotation or wobble of the electrical terminal 60A (particularly in a plane in which the terminal channel 50A or the electrical terminal 60A extends) during insertion into the terminal channel 50A, as compared to having only one first protrusion 72.

The first surface 61 of the mounting portion 65 of the electrical terminal 60A is formed with a pocket 71 (FIG. 5) recessed into the mounting portion 65 from the first surface 61, and two (or other number of) first protrusions 72 protrude from the pocket 71 and beyond the first surface 61 to be engaged into the corresponding recesses 52, which increases an effective engagement length of the first protrusions 72 with the recesses 52 without changing other dimensions of the electrical terminal 60A and the base 40, and thus achieves improved stabilizing and guiding functions. The first protrusion 72 may include a varying cross section perpendicular to its protruding direction in a portion of its extending or protruding direction, such as a portion 57 of a convex-concave structure in FIG. 5.

In case the above function can be provided, the distance by which the first protrusion 72 extends in the second direction T (starting from the first surface 61 when it protrudes from the first surface 61, and starting from an inner surface of the pocket 71 when it protrudes from the pocket 71) is not limited. In some embodiments, the distance by which the first protrusion 72 extends is equal to or slightly less than the depth of the corresponding recess 52 so as to ensure the entire first protrusion 72 extends into the recess 52 and thus the entire distance acts as the effective engagement length.

Returning to the second surface 63 of the mounting portion 65 of the electrical terminal 60A, the electrical terminal 60A includes at least two second protrusions 74 protruding from the second surface 63 in the second direction T, and the second protrusions 74 protrude out of the terminal channel 50A when the electrical terminal 60A is mounted within the terminal channel 50A. As described above, the second surface 63 of the electrical terminal 60A is recessed in the terminal channel 50A, and the at least two second protrusions 74 protrude out of the terminal channel 50A or protrude beyond a surface of the first platform 42a of the base 40. Meanwhile, the first platform 42a of the base 40 includes a plurality of raised ribs 76 (FIG. 4), and each raised rib 76 is disposed between two adjacent terminal channels 50A in the third direction A and elongated in the first direction L.

The second protrusion 74 of the mounting portion 65 of the electrical terminal 60A and the raised rib 76 of the base 40 both protrude from the first platform 42a of the base 40 toward the first inner surface 11 of the connector housing 10 in the second direction T and are alternately arranged in the third direction A. The second protrusion 74 of the electrical terminal 60A and the raised rib 76 of the base 40 may protrude from the first platform 42a by substantially the same distance, such as extending to the first inner surface 11 or forming a slight gap from the first inner surface 11. Such a configuration can stabilize the terminal assembly 20 in the housing cavity 15 reliably and avoid shifting or shaking of the terminal assembly 20.

The number of the second protrusions 74 may be at least two, to prevent the electrical terminal 60A from shaking within the terminal channel 50A. At least two second protrusions 74 on the second surface 63, in combination with two or more first protrusions 72 on the first surface 61, provides a better effect of preventing the electrical terminal 60A from shaking in the terminal channel 50A. Of course, the second protrusions 74 on the second surface 63 are not limited to two. The second surface 63 may further include an additional protrusion 73 between the two second protrusions 74, and the distance by which the additional protrusion 73 protrudes from the second surface 63 is equal to or less than the protruding distance of the two second protrusions 74, so as to ensure that the two outermost second protrusions 74 in the first direction L function sufficiently. In some embodiments, the electrical terminal 60A may not include the second protrusion 74.

As described above, the plurality of electrical terminals 60A are mounted within the plurality of terminal channels 50A formed in the first base surface 42 of the base 40. When the terminal assembly 20 is inserted or assembled into the housing cavity 15 of the connector housing 10 (from the second mating port 18), the plurality of electrical terminals 60A provide: at least one (two in the illustrated example) mating portions on the first side (mating portions 62a and 66a of the first arm 62 and the third arm 66) and at least one (two in the illustrated example) mating portions on the second side (mating portions 64a and 68a of the second arm 64 and the fourth arm 68) which protrude into the first slot 45a and the second slot 45b, respectively, so that the electrical terminal (assembly) of the first electrical device (inserted into the first slot 45a) connected to the first mating port 16 of the electrical connector 100 can be electrically connected with the electrical terminal (assembly) of the second electrical device (inserted into the second slot 45b) connected to the second mating port 18 of the electrical connector 100.

The electrical connector 100 of the present application is further particularly suitable for the first electrical device and the second electrical device each including two electrical terminal assemblies. The electrical connector 100 further provides a third slot 45c and a fourth slot 45d that are symmetrically arranged with the first slot 45a and the second slot 45b about the base 40 in the second direction T. In the first direction L, the third slot 45c and the fourth slot 45d are spaced apart by the second platform 44a on the second base surface 44 of the base 40. The second platform 44a on the second base surface 44 and the first platform 42a on the first base surface 42 are symmetrically arranged with respect to the base 40 in the second direction A.

If the aforementioned plurality of electrical terminals 60A are referred to as a first plurality of electrical terminals and the corresponding plurality of terminal channels 50A provided in the first base surface 42 of the base 40 are referred to as a first plurality of terminal channels, the electrical connector 100 of the present application further includes a second plurality of electrical terminals 60B and the base 40 correspondingly includes a second plurality of terminal channels formed in the second base surface 44. The electrical terminals of the second plurality of electrical terminals 60B and the electrical terminals of the first plurality of electrical terminals 60A have identical configurations as shown in FIG. 5 and described in detail above. The second plurality of electrical terminals 60B differ from the first plurality of electrical terminals 60A only in that the first plurality of electrical terminals 60A are mounted within the first plurality of terminal channels 50A formed in the first base surface 42 with the mating portions of the respective electrical terminals protruding into the first and second slots 45a and 45b, respectively, while the second plurality of electrical terminals 60B are mounted within the second plurality of terminal channels formed in the second base surface 44 with mating portions of the respective electrical terminals protruding into the third and fourth slots 45c and 45d, respectively. The second plurality of electrical terminals 60B and the first plurality of electrical terminals 60A are oriented completely opposite in the second direction T when assembled to the base 40 and then assembled to the connector housing 10.

It can also be seen from FIGS. 3 and 6 that each of the second plurality of electrical terminals 60B is not properly aligned in the second direction T relative to a corresponding one of the first plurality of electrical terminals 60A in the second direction T, but is offset in the third direction A relative to each other. In a cross-section perpendicular to the third direction A shown in FIG. 6, only the first plurality of terminal channels 50A extending from the first base surface 42 and the electrical terminals therein are shown. Compared to a structure in which each of the second plurality of electrical terminals 60B is right aligned with the corresponding one of the first plurality of electrical terminals 60A in the second direction T and thus two terminal channels are provided in one and the same cross section, the size or thickness of the base 40 of the present electrical connector 100 in the second direction T is minimized and the size of the entire electrical connector 100 in the second direction T is minimized, while still ensuring the strength of the base 40 and ensuring various properties of the electrical connector 100.

Each electrical terminal (and the corresponding terminal channel) of the first plurality of electrical terminals 60A may be aligned with each electrical terminal (and the corresponding terminal channel) of the second plurality of electrical terminals 60B in the second direction T.

FIG. 6 illustrates a connector assembly including the present electrical connector 100. In addition to the electrical connector 100, the connector assembly further includes a first electrical device 200 attached to the first mating port 16 of the electrical connector 100, and a second electrical device 300 attached to the second mating port 18 of the electrical connector 100.

The first electrical device 200 may include a first device housing 210 and two electrical terminal assemblies 220 and 230 supported by the first device housing 210. In this embodiment, the electrical terminal assemblies 220 and 230 of the first electrical device 200 are receptacle terminal assemblies, specifically cable terminal assemblies with cables connected thereto. The electrical terminals of the electrical terminal assemblies 220 and 230 are cable terminals which may be crimp terminals.

The first electrical device 200 is attached to the first mating port 16 of the electrical connector 100 such that a portion of the first device housing 210 thereof, along with a portion of the two electrical terminal assemblies 220 and 230 supported thereby, are inserted into the first and third slots 45a and 45c, respectively. In this way, the two electrical terminal assemblies 220 and 230 of the first electrical device 200 are electrically connected to the mating portions of the first and third arms of each of the first and second plurality of electrical terminals 60A and 60B, respectively, of the electrical connector 100. As such, mechanical and electrical connections between the first electrical device 200 and the electrical connector 100 are achieved.

The second electrical device 300 may include a second device housing 310 and two electrical terminal assemblies 320 and 330 supported by the second device housing 310. The electrical terminal assemblies 320 and 330 of the second electrical device 300 are shown as flat cable terminal assemblies, and the electrical terminal assemblies 320 and 330 include a plurality of flat cable terminals.

As shown, the second electrical device 300 is attached to the second mating port 18 of the electrical connector 100 such that a portion of its second device housing 310 and a portion of the corresponding electrical terminal assemblies 320 and 330 supported thereby are inserted into the second and fourth slots 45b and 45d, respectively. In this way, the two electrical terminal assemblies 320 and 330 of the second electrical device 300 are electrically connected to the mating portions of the second and fourth arms of each of the first and second plurality of electrical terminals 60A and 60B, respectively, of the electrical connector 100. As such, the second electrical device 300 is electrically connected to the electrical connector 100.

As can be seen in the cross-sectional view of FIG. 6, stepped surfaces 11d and 13d are formed on the first inner surface 11 and the second inner surface 13 of the electrical connector 100, respectively, and stepped surfaces 42d and 44d engage the second device housing 310 when the second electrical device 300 is inserted into the second slot 45b and the fourth slot 45d of the housing cavity 15 to indicate that the second electrical device 300 has been inserted in place, avoiding the second electrical device 300 from over-insertion in the first direction L or in an insertion direction.

Also shown in FIG. 6, the connector housing 10 includes a securing device removably disposed thereon or integrally formed therewith. In some embodiments, the securing device is a snap element 80. The snap member 80 is detachably connected to any outer surface of the connector housing 10. For example, for convenience of use, the snap member 80 is disposed on a bottom surface of the connector housing 10 in its normal use. The snap element 80 may include a claw 84 formed with a snap slot 82. The snap slot 82 may be configured to be snapped to a plate member such as a circuit board (e.g., a printed circuit board) 85. The provision of the securing device enables the electrical connector 100 to meet the use requirements of users in different environments, and improves the convenience and flexibility of use.

Therefore, the electrical connector 10 realizes the electrical connection between the first electrical device 200 (an electrical device including cable terminals, such as a cable connector) and the second electrical device 300 (an electrical device including flat cable terminal(s), such as a flat cable connector).

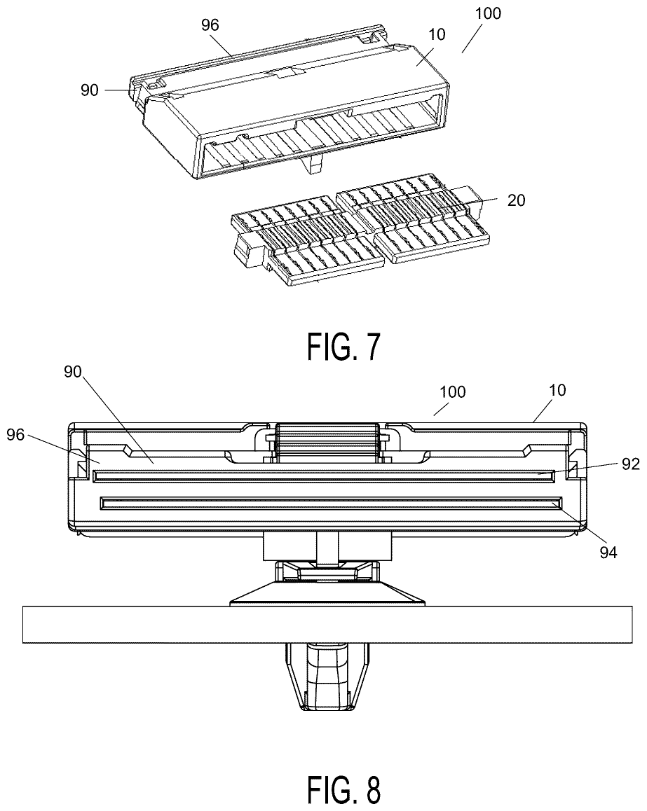

FIG. 7 illustrates an electrical connector 100 according to another embodiment of the present application. It differs from the first embodiment in FIGS. 1-6 in terms of the connector housing 10. FIG. 8 illustrates a side view of the electrical connector 100 of FIG. 7.

In addition to the details described above with respect to the connector housing 10, the present connector housing 10 includes a support portion 90 for supporting an electrical terminal assembly to be inserted into the first slot 45a and the third slot 45c. The support portion 90 includes a first slit 92 and a second slit 94 aligned with the first slot 45a and the third slot 45c, respectively, in the first direction L, and they are spaced apart by a distance in the second direction T and positioned in the second direction T such that a first electrical terminal assembly inserted through the first slit 92 can be electrically connected with the mating portions of the arms (62 and 66) of each of the first plurality of electrical terminals 60A of the electrical connector 100, and a second electrical terminal assembly inserted through the second slit 94 can be electrically connected with the mating portions of the arms (64 and 68) of each of the second plurality of electrical terminals 60B of the electrical connector 100. In particular, this embodiment is applicable if the electrical terminal assembly is a flat cable terminal assembly including flat cable terminal(s).

FIG. 8 illustrates a side view of the electrical connector 100 of FIG. 7. The first slit 92 and the second slit 94 of the support portion 90 of the connector housing 10 are clearly visible therefrom.

With the present electrical connector, a first electrical device connected to the first mating port of the electrical connector 100 may have its electrical terminal assemblies inserted directly into the first and third slots of the electrical connector 100 and electrically connected to the electrical terminal assemblies of a second electrical device inserted into the second and fourth slots. In an embodiment, the first electrical device 200 may be an electrical device including electrical terminal(s) in the form of flat cable terminal(s), such as a flat cable connector. The second electrical device 300 is also an electrical device including electrical terminal(s) in the form of flat cable terminal(s), such as a flat cable connector. For example, the first electrical device 200 may only have its electrical terminal assemblies inserted into the first and third slots of the present electrical connector, and the second electrical device 300 may have its electrical terminal assemblies, as well as a portion of the device housing, inserted into the second and fourth slots of the present electrical connector. Therefore, the electrical connector achieves an electrical connection between the flat cable electrical device and the flat cable electrical device, and may be applied to a battery management system or another electronic device assembly field.

FIG. 9 shows another connector assembly of the present application, which includes an electrical connector 100 and a first electrical device 200 and a second electrical device 300 connected thereto.

Different from the first electrical device 200 in FIG. 6, electrical terminal assemblies 220 and 230 of the first electrical device 200 in this embodiment are flat cable terminal assemblies. Specifically, the first electrical device 200 includes a first electrical terminal assembly 220 inserted into the first slot 45a and a second electrical terminal assembly 230 inserted into the third slot 45c. Similar to FIG. 8, the first electrical device 200 only has its electrical terminal assemblies 220 and 230 partially inserted into the first and third slots 45a and 45c of the electrical connector 100.

In this connection, the first slot 45a and the third slot 45c of the electrical connector 100 are configured to directly receive an electrical terminal assembly (e.g., a flat cable terminal assembly) having a smaller size in the second direction T, and the first slot 45a and the third slot 45c have correspondingly smaller sizes in the second direction T. Thus, a first cavity section of the housing cavity 15 of the connector housing 10 at the first slot 45a and the third slot 45c has a correspondingly smaller size in the second direction T, especially smaller than that of an intermediate cavity section of the housing cavity 15 corresponding to the first and second platforms 42a and 44a of the base 40 of the terminal assembly 20. Thus, the first and second inner surfaces 11 and 13 bounding the housing cavity 15 form the stepped surfaces 11e and 13e, respectively. These stepped surfaces 11e and 13e may replace the flange 17 on the connector housing 10 of the first embodiment illustrated in FIGS. 1-6, to act as a stop feature that engages the platform 42a of the base 40 of the terminal assembly 20 to prevent further insertion when the terminal assembly 20 is inserted into the housing cavity 15 from the second mating port 18.

The second electrical device 300, similar to the second electrical device in FIG. 6, includes a second device housing 310 and first and second electrical terminal assemblies 320, 330 supported thereby. A portion of the second device housing 310 and a portion of each of the first and second electrical terminal assemblies 320, 330 are inserted into the second and fourth slots 45b, 45d, respectively.

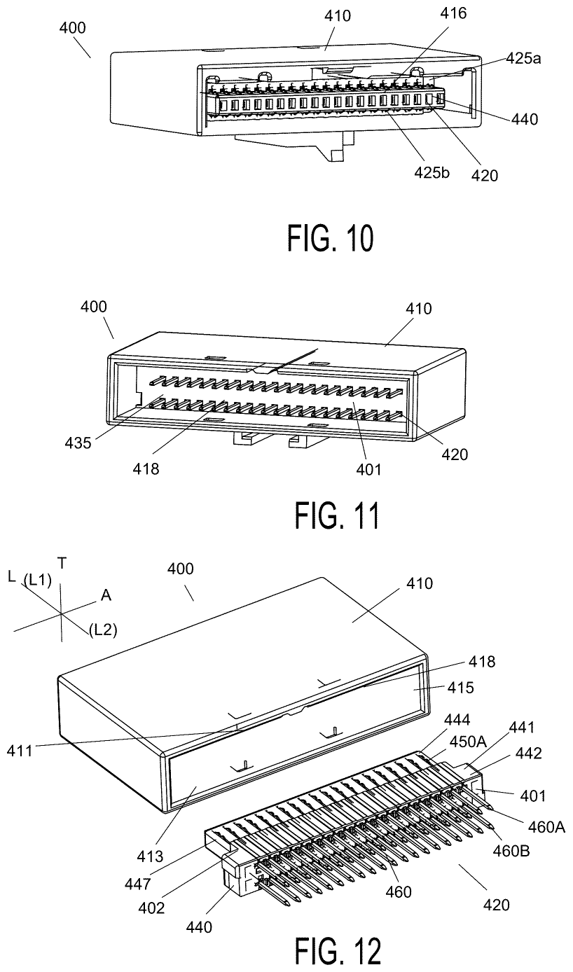

Reference will be made to FIG. 10, and an electrical connector 400 for electrically connecting a first electrical device and a second electrical device according to yet another embodiment of the present application will be described.

The electrical connector 400 may include a connector housing 410 made of an insulating material and a terminal assembly 420 housed within the connector housing 410. The terminal assembly 420 may include a base 440 and a plurality of electrical terminals supported by the base 440. The base 440 may also be made of an insulating material. In some embodiments, the connector housing 410 and the base 440 of the terminal assembly 420 may be formed as a unitary piece. Examples of the insulating material of the present application include, but are not limited to, plastic, nylon, liquid crystal polymer (LCP), polyphenylene sulfide (PPS), high-temperature nylon or polyphenylene oxide (PPO) or polypropylene (PP).

A housing cavity 415 extends through the connector housing 410 along a first direction L. The terminal assembly 420 can be inserted or assembled into the housing cavity 415 of the connector housing 410 along the first direction L, forming a first mating port 416 (FIG. 10) and a second mating port 418 (FIG. 11) on opposite sides of the electrical connector 400 in the first direction L. The first and second mating ports 416 and 418 are configured to receive first and second electrical devices, respectively. The connector housing 410 can serve as a support frame for the terminal assembly 420. In a second direction T perpendicular to the first direction L, the housing cavity 415 is bounded by opposing upper and lower surfaces 411, 413 of the connector housing 410. Note that the directional terms “upper” and “lower” refer to two opposite orientations in the second direction T, and shall be understood with reference to the placement of components in the drawings. If the orientation of components in the drawings is changed, the understanding of directional terms should be changed accordingly.

FIGS. 10 and 11 are assembly views of the electrical connector 400 from two different angles, and FIG. 12 shows that the terminal assembly 420 of the electrical connector 400 are removed from the housing cavity 415.

The base 440 of the terminal assembly 420 includes a first portion 442 extending in the second direction A and a second portion 444 protruding from the first portion 442 in the first direction L. The first portion 442 has a first upper surface 441 and an opposite first lower surface in the second direction T, and the second portion 444 has a second upper surface 447 and an opposite second lower surface in the second direction T. The first upper surface 441 of the first portion 442 and the second upper surface 447 of the second portion 444 together constitute a base upper surface (or a first base surface) 402, and the first lower surface of the first portion 442 and the second lower surface of the second portion 444 together constitute a base lower surface (or a second base surface). The base 440 includes a first end surface 401 (FIG. 12) and an opposite second end surface in the first direction L, and the first end surface 401 and the second end surface are determined by the first portion 442 and the second portion 444, respectively.

When the terminal assembly 420 is mounted in the housing cavity 415 of the connector housing 410, the first upper surface 441 and the first lower surface of the first portion 442 of the base engage the opposing upper surface 411 and the opposing lower surface 413, respectively, of the connector housing 410, spacing the first mating port 416 and the second mating port 418 from an interior of the connector housing 410. At the first mating port 416, the second upper surface 447 and the second lower surface of the second portion 444 of the base 440 define the first slot 425a and the second slot 425b (FIG. 10), respectively, together with the opposing upper surface 411 and the opposing lower surface 413 of the connector housing 410 in the second direction T, and the first slot 425a and the second slot 425b are spaced apart by the second portion 444 of the base 440. At the second mating port 418, a common slot 435 (FIG. 11) is bounded by the upper surface 411 and the lower surface 413 of the connector housing 410.

The base 440 includes a first plurality of terminal channels 450A extending from the base upper surface 402 into the base 440 along the second direction T, and the first plurality of terminal channels 450A are spaced apart in a third direction A perpendicular to the first direction L and the second direction T, forming a row. Accordingly, a plurality of electrical terminals 460 includes a first plurality of electrical terminals 460 A corresponding to the first plurality of terminal channels 450A. Each of the first plurality of electrical terminals 460A is partially received within a respective one of the first plurality of terminal channels 450 A, and includes an arm contact portion extending into the first slot 425a at the first mating port 416 and a pin contact portion extending into the common slot 435 at the second mating port 418. The arm contact portion is configured for electrical connection with an electrical terminal of an electrical terminal assembly of a first electrical device inserted into the first slot 425a, and the pin contact portion is configured for electrical connection with an electrical terminal of an electrical terminal assembly of a second electrical device inserted into the common slot 435.

The base 440 further includes a second plurality of terminal channels extending from the lower surface of the base in the second direction T into the base 440, and the second plurality of terminal channels are spaced apart in the third direction A to form a row. Accordingly, the plurality of electrical terminals 460 includes a second plurality of electrical terminals 460B corresponding to the second plurality of terminal channels. Each of the second plurality of electrical terminals 460B is partially received within a respective one of the second plurality of terminal channels, and includes an arm contact portion extending into the second slot 425b at the first mating port 416 and a pin contact portion extending into the common slot 435 at the second mating port 418. The arm contact portion is configured for electrical connection with a corresponding electrical terminal of an electrical terminal assembly of a first electrical device inserted into the second slot 425b, and the pin contact portion is configured for electrical connection with a corresponding electrical terminal of an electrical terminal assembly of a second electrical device inserted into the common slot 435.

The electrical terminals of the second plurality of electrical terminals 460B and the electrical terminals of the first plurality of electrical terminals 460A have identical configurations. As the orientations of the second plurality of terminal channels and the first plurality of terminal channels 450A are opposite in the second direction T, the mounting orientations of the second plurality of electrical terminals 460B and the first plurality of electrical terminals 460A are opposite in the second direction T.

Only one terminal channel of the first plurality of terminal channels 450A and a corresponding one electrical terminal of the first plurality of electrical terminals 460 A will be described below, and for simplicity, the terminal channel and electrical terminal are indicated as 450 and 460 below.

As described above, the terminal channel 450 extends from the base upper surface 402 into the base 440 in the second direction T. The terminal channel 450 extends from the first end surface 401 of the first portion 442 into the base 440 in the first direction L and terminates within the second portion 444, without extending through the base 440. The terminal channels 450 of the present electrical connector 400 are each configured to receive a portion, but not an entire, of corresponding electrical terminals. A portion of the electrical terminal 460 is received within the corresponding terminal channel 450 and a portion extends from the terminal channel 450 into the common slot 435 within the second mating port 418.

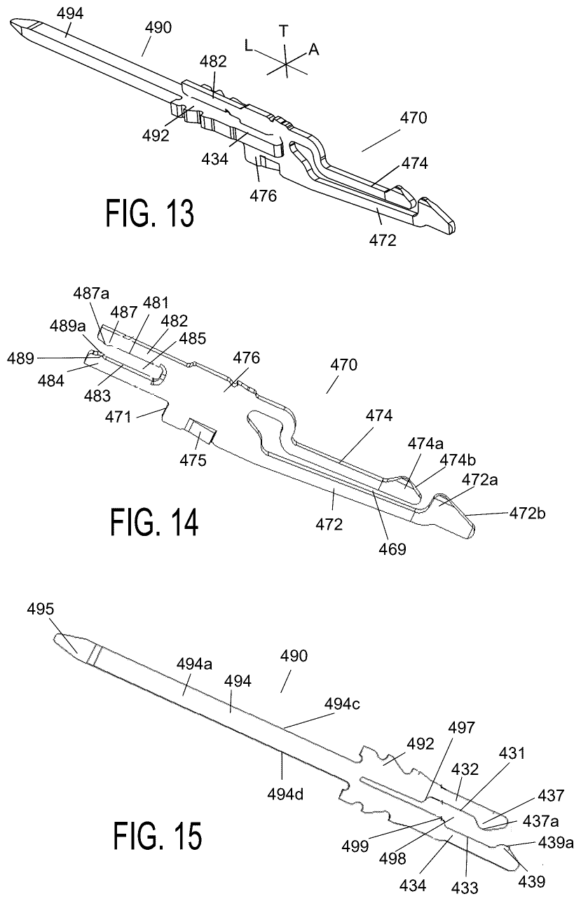

The electrical terminal 460 of the present application will be described below with reference to FIGS. 13 to 15.

The electrical terminal 460 includes a first terminal element 470 and a second terminal element 490 connected together. In the first direction L, the electrical terminal 460 includes an arm portion extending in the first direction L and provided by the first terminal element 470, a pin portion extending in the first direction L and provided by the second terminal element 490, and a retention portion which is formed by connecting the first terminal element 470 and the second terminal element 490.

The retaining portion of each electrical terminal 460 is adapted to be received in a channel segment of the terminal channel 450 in the first portion 442 of the base 440, the arm portion of each electrical terminal is adapted to be received in a channel segment of the terminal channel 450 in the second portion 444 of the base 440, and the pin portion of each electrical terminal 460 is adapted to protrude out of the terminal channel 450 to be suspended in the common slot 435 of the second mating port 418. The arm portion of each electrical terminal 460 (in particular, the first terminal element 470) includes a (arm) contact portion which protrudes out of the terminal channel 450 in the second direction T and into the first slot 425a for electrical connection with an electrical terminal of an inserted external electrical device. The pin portion of each electrical terminal 460 (in particular, the second terminal element 490) includes a (pin) contact portion which protrudes into the common slot 435 and extends in the first direction L for electrical connection with an electrical terminal of an inserted external electrical device.

Referring to FIG. 14, the arm portion provided by the first terminal element 470 includes a first arm 472 and a second arm 474 spaced apart in the second direction T, wherein the first arm 472 is configured to be proximate to the bottom of the terminal channel 450 when the electrical terminal 460 is mounted within the respective terminal channel 450 and form an initial void from the bottom of the terminal channel 450 to allow the first arm 472 to deflect into the initial void. The second arm 474 and the first arm 472 form a gap 469 therebetween to allow the second arm 474 to deflect relative to the first arm 472, or vice versa.

The first and second arms 472 and 474 include first and second contact portions 472a and 474a, respectively, projecting at or near their free ends. In the first direction L, the first arm 472 extends farther than the second arm 474 so that the contact portions 472a and 474a of the first and second arms 472 and 474 can be offset in the first direction L and protrude in the same manner, protruding from the base 440 by substantially the same distance. In this way, the contact portions 472a and 474a of the two arms may be substantially at the same height in the second direction T. The contact portions 472a and 474a of the first arm 472 and the second arm 474 may include inclined surfaces 472b and 474b for guiding purpose, to guide the insertion of the electrical terminals of an external connector.

Regarding various details of the first arm 472 and the second arm 474, references can be made to those described above with respect to the electrical connector 100, and the same contents will not be repeated here.

In the illustrated embodiment, the entire first terminal element 470 is provided as, but not limited to, a plate-like member, which may be, but is not limited to, a stamped unitary piece.

The first terminal element 470 further includes a base 476 and a connection feature extending from the base 476, the connection feature extending opposite to the arm portion in the first direction L. In some embodiments, the base 476 has a generally rectangular shape.

The connection feature includes two legs 482 and 484 extending from the base 476. The two legs 482 and 484 extend generally parallel to each other and are spaced apart by a gap 485. The two legs 482 and 484 have inner surfaces 481 and 483 facing each other and bulges 487 and 489 protruding from the inner surfaces 481 and 483 into the gap 485. Bulges 487 and 489 may be provided near ends of the two legs 482 and 484 and may be connected to the respective inner surfaces on both sides by inclined surfaces. The two bulges 487 and 489 include arm contact portions 487a and 489a (or arm contacting vertices) that define a minimum first spacing.

In FIG. 15, the second terminal element 490 is also integrally provided as a plate-shaped member, but is not limited thereto. The second terminal element 490 may also be, but is not limited to, a stamped unitary piece.

The second terminal element 490 includes a base 492 and a pin portion 494 extending in the first direction from the base 492. The entire pin portion 494 serves as an electrically conductive contact portion of the electrical terminal 460 of the electrical connector 400 for electrical connection with an electrical terminal of a second electrical device mounted at the second mating port 418 of the electrical connector 400.

The pin portion 494 may have opposite first and second surfaces determining a thickness in the second direction T, and first and second sides 494c and 494d determining a width in the third direction A. The first surface 494a and the second surface serve as conductive contact surfaces for electrical connection with the electrical terminal of an external electrical device. The contact surface is planar in the illustration, but the application is not limited to a planar contact surface. The pin portion 494 has a tip 495 with a gradually decreasing thickness and a gradually decreasing width, the gradually decreasing thickness of the tip 495 is determined by end portions of the first surface 494a and the second surface extending obliquely toward each other, and the gradually decreasing width of the tip 495 is determined by end portions of the first side 494c and the second side 494d extending obliquely toward each other. The fact that the first and second sides 494c, 494d and the first and second surfaces 494a, 494b extend obliquely to define the tip 495 functions to guide and facilitate the engagement with a mating electrical terminal.

The base 492 has a width greater than that of the pin portion 494. Third and fourth legs 432 and 434 extend from the base 492 opposite to the pin portion 494 and are spaced apart by a slit 498, forming cantilevers. The third and fourth legs 432 and 434 have inner surfaces 431 and 433 facing each other, and bulges 437 and 439 extending oppositely from the inner surfaces 431 and 433 into the slit 498. The bulges 437 and 439 have pin contact portions 437a and 439a (pin contacting vertices) that define a minimum second spacing. In the illustrated embodiment, the slit 498 may have a slit width which varies in the first direction L.

The electrical terminal 460 is formed by connecting the second terminal element 490 and the first terminal element 470. Referring to FIG. 13, the bulges 487 and 489 of the two legs 482 and 484 of the first terminal element 470 are snapped on the base 492 of the second terminal element 490, and the bulges 437 and 439 of the two legs 432 and 434 of the second terminal element 490 are snapped on the base 476 of the first terminal element 470.

The connection is achieved by operations including: inserting the base 476 of the first terminal element 470 between the two legs 432 and 434 of the second terminal element 490 and inserting the base 492 of the second terminal element 490 between the two legs of the first terminal element 470, and moving the two elements toward each other. The first terminal element 470 and the second terminal element 490 are connected completely when their bases or other portions abut each other. As an example, this may be a surface 471 (FIG. 14) of the base 476 of the first terminal element 470 abuts a projection (e.g., 497 or 499 in FIG. 15) on one or both of the legs of the second terminal element 490 or abuts a narrowed portion of the slit 498, or may be a surface or projection of the second terminal element 490 abuts the first terminal element 470.

In this way, the first terminal element 470 and the second terminal element 490 are inserted with one into the gap between the two legs of the other, and both have two contact portions snapped on each other. This ensures the stability and reliability of connection and the stability of signal transmission.

The first spacing between the arm contact portions 487a and 489a of the bulges 487 and 489 of the first terminal element 470 is designed to be smaller than a thickness of the base 492 of the second terminal element 490, so that the arm contact portions 487a and 489a of the bulges 487 and 489 of the first terminal element 470 are snapped or clamped on the base 492 of the second terminal element 490 by an elastic force. The second spacing between the pin contact portions 437a and 439a of the bulges 437 and 439 of the second terminal element 490 is smaller than a thickness of the base 476 of the first terminal element 470, so that the pin contact portions 437a and 439a of the bulges 437 and 439 of the second terminal element 490 are snapped or clamped on the base 476 of the first terminal element 470 by an elastic force. The smaller contact surface achieves a larger clamping force, achieving a reliable and stable electrical connection between the first terminal element 470 and the second terminal element 490.

Changing a relative position of the gap 485 between the two legs 482 and 484 of the first terminal element 470 and the contact portions 472a and 472b of the arm portions in the second direction T can change a relative position of (the pin contact portion of) the pin portion and (the arm contact portions of) the arm portions of the entire electrical terminal 460 in the second direction.

As described above, the first terminal element 470 and the second terminal element 490 are securely connected together to form the electrical terminal 460, either of which provides two contact portions to be electrically connected and mechanically connected to the other, ensuring stability of signal transmission. Specific dimensions of the arm contact portion and the pin contact portion may be appropriately designed to obtain an appropriate (e.g., smaller) contact surface and an appropriate (e.g., larger) contact pressure, thereby improving contact stability and reliability between the two terminal elements.

The electrical terminal 460 is composed of a first terminal element 470 including the arm contact portions and a second terminal element 490 including the pin contact portion. Thus, the first terminal element 470 having different specifications (shapes and/or sizes) and the second terminal element 490 having different specifications (shapes and/or sizes) may be provided, and the suitable first terminal element 470 and the suitable second terminal element 490 may be selected for assembly to form the electrical terminal 460 A that can meet user requirements. In this way, the electrical connector of this application can meet diversified use requirements and have high universality.

The arm contact portions of the electrical terminal 460 of the present application enable the corresponding mating port to be connected to an external electrical device including an electrical terminal assembly including flat cable terminal(s), and the pin contact portion of the electrical terminal 460 enables the corresponding mating port to be connected to an external electrical device including an electrical terminal assembly (a cable terminal assembly, or a crimp terminal assembly) including receptacle terminal(s). In this way, the electrical connector enables the electrical connection of two different types of electrical devices. The connection between the external electrical device and the electrical connector of the present application is detachable, which provides a high flexibility.

In some embodiments, the plate-shaped first terminal element 470 and the plate-shaped second terminal element 49 may have different thicknesses. In some embodiments, the first thickness is less than the second thickness.

Since the arm contact portions of the electrical terminal 460 (the first terminal element 470) are configured to be electrically connected with the flat cable terminal of the electrical terminal assembly of the first electrical device and the flat cable terminal is usually in the form of a contacting strip, the thickness of the first terminal element 470 is designed to be relatively small, which facilitates to increase the contact pressure and improve the reliability and stability of the contact.

The pin contact portion of the electrical terminal 460 (the second terminal element 490) is configured to be electrically connected with the receptacle electrical terminal (such as the crimp terminal or the cable terminal) of the electrical terminal assembly of the second electrical device, and thus the thickness of the second terminal element 490 is designed to be relatively large, which facilitates to increase the contact area and ensure the transmission efficiency and connection stability. As an example, the thickness of the first terminal element 470 is about 0.2 mm, and the thickness of the second terminal element 490 is 0.4-0.5 mm.

In addition, the base 476 of the first terminal element 470 includes an outwardly protruding limiting block 457 which is configured to be engaged with a corresponding feature on the base 440 during insertion of the electrical terminal 460 into the terminal channel 450 to avoid excessive insertion of the electrical terminal.

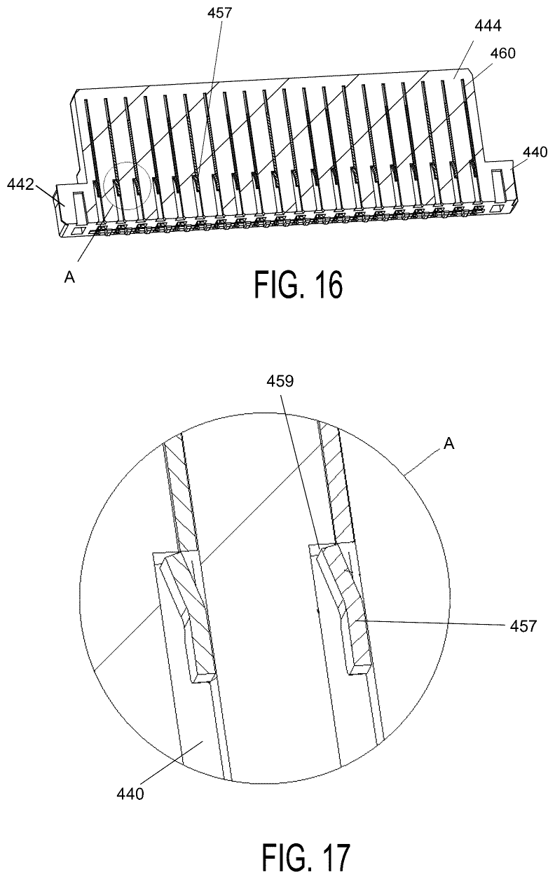

In particular, the second portion 444 of the base 440 has a limiting recess 459 (FIG. 17), and during a process in which the electrical terminal 460 formed by connection of the first terminal element 470 with the second terminal element 490 is inserted into the terminal channel 450, the limiting block 457 and the limiting recess 459 are engaged with each other to prevent the electrical terminal from further moving or being inserted further in the second direction T, achieving a positioning effect. Details are shown in FIGS. 16 and 17.

The provision of the limiting features can prevent the electrical terminal 460 from being excessively inserted into the terminal channel 450, avoid any adverse effects that may be caused by the excessive insertion of the electrical terminal 460 to the electrical connection between the arm contact portions of the electrical terminal 460, in particular the first terminal element 470, and the electrical terminal in the form of the contact strip or flat cable of the first electrical device, overcome the instability of the electrical connection that may be caused thereby, ensure the consistency of the insertion depths of the electrical terminals, in particular the first terminal element, and improve the product quality.

In the illustrated example, the limiting block 457 is disposed on the base 476 of the first terminal element 470. The limiting block has a substantially triangular shape. However, it should be understood for those skilled in the art that this is only an example without limitation. The limiting block 457 may be disposed at any suitable location of the first terminal element 470. Optionally, it is also possible that the limiting block 457 is provided on the second terminal element 490.

The features for providing the limiting effect for the insertion of the electrical terminal 460 are not necessarily to include the limiting block and the limiting recess as shown, and any interference features capable of achieving the same effect may be used.

It should also be understood that although the electrical terminal 460 in the illustrated embodiment includes the first terminal element 470 and the second terminal element 490 provided separately, the present application is not limited thereto. The electrical terminal 460 may be a unitary piece.

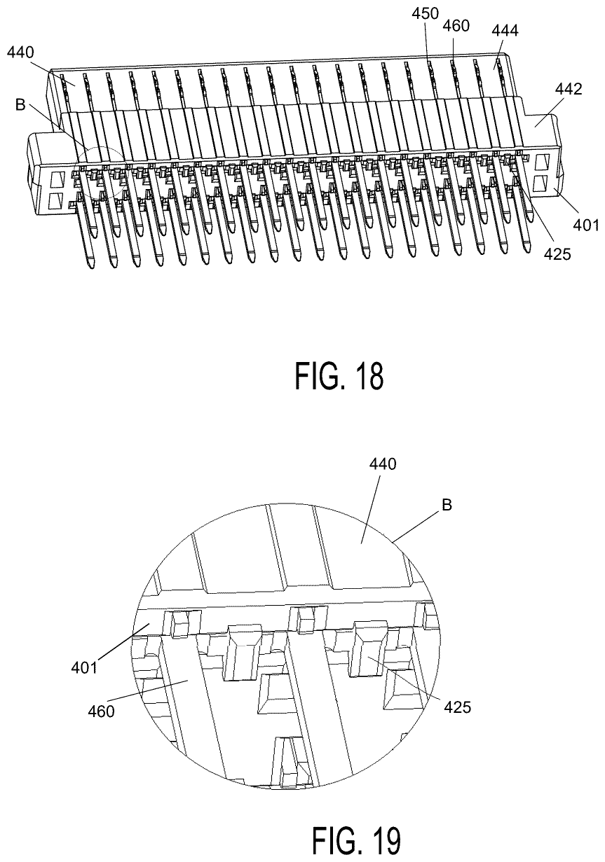

In some embodiments, as shown in FIGS. 18 and 19, a bulge 425 protrudes outwardly (e.g., substantially in the first direction L) is provided on the base 440 of the terminal assembly 420 of the electrical connector 400, for example, on an end surface 401 of the first portion 442 thereof, between adjacent terminal channels 450 and thus between the pin contact portions (pin portions 494) of the electrical connector 400. The bulge 425 may have any desired shape, size, and protruding distance. The provision of the bulge 425 can increase the creepage distance between adjacent electrical terminals, thereby improving the electrical performance of the connector.

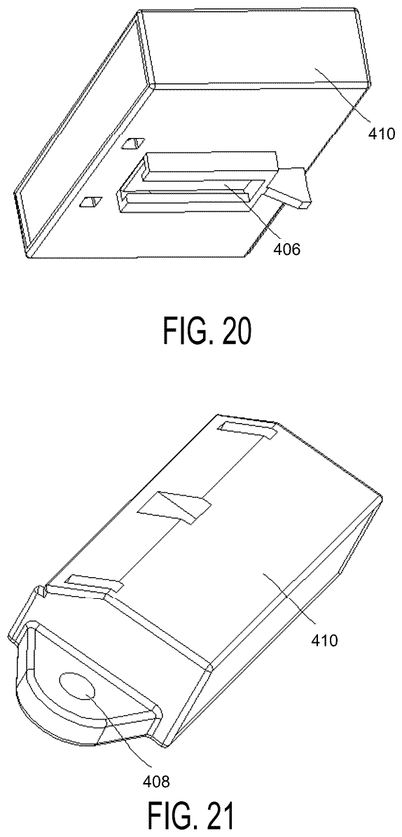

A variety of different electrical connectors have been described above with reference to the drawings, which may include a variety of different connector housings. In some embodiments, one or more securing devices may be provided on the connector housing of the electrical connector for securing to an external or other component. For example, the connector housing may include a snap-form securing device 406 (FIG. 20) with a snap slot, or a threaded-connection securing device 408 (FIG. 21) with a lug having a threaded hole or the like. When multiple securing devices are provided, different types of securing devices are disposed on different outer surfaces.

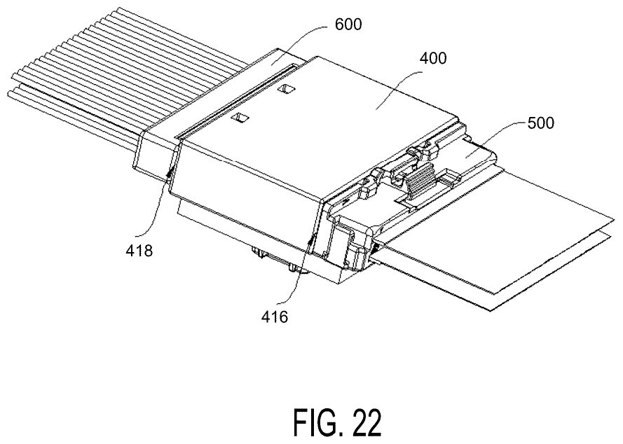

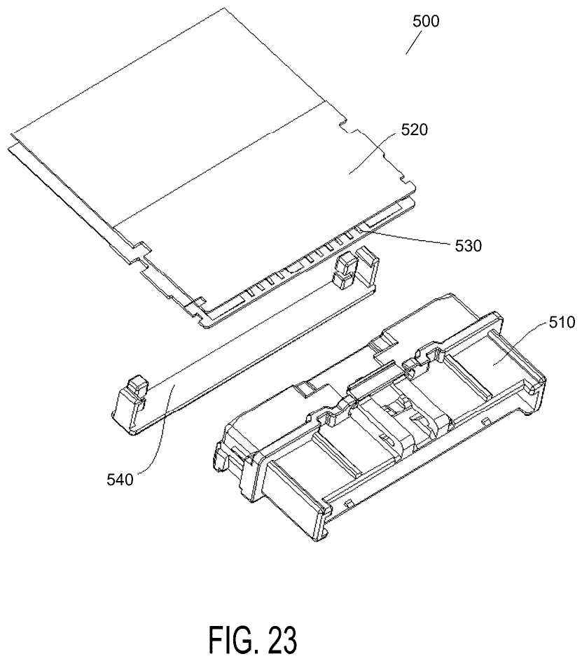

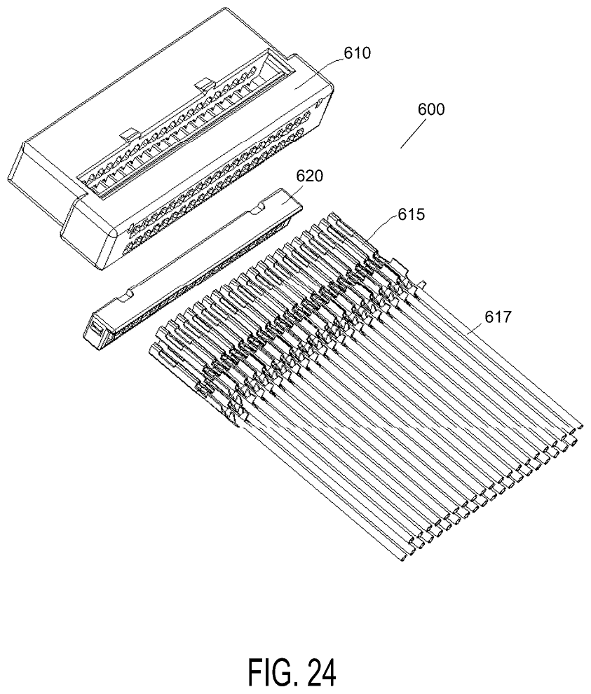

FIGS. 22-26 provide a connector assembly. The connector assembly includes the electrical connector 400 described with reference to FIG. 10 and first and second electrical devices 500, 600 attached to the first and second mating ports 416, 418, respectively, of the electrical connector 400.

The first electrical device 500 includes a first device housing 510 and first and second electrical terminal assemblies 520, 530 supported by the first device housing 510. A clamping device 540 is used to secure the first and second electrical terminal assemblies 520, 530 to the first device housing 510. In the illustrated example, the clamping device 540 may be in the form of an FPC/FFC position assurance (FPA) member, the FPA member snapped to the first device housing 510 and abuts the electrical terminal assemblies to lock the electrical terminal assemblies to the first device housing 510. The clamping device 540 improves the connection stability of the first electrical terminal assembly 520 and the second electrical terminal assembly 530 with the first device housing 510, and in turn ensures the contact stability of the respective electrical terminal assemblies 520 and 530 of the first electrical device 500 with (the arm contact portions of) the electrical terminals of the electrical connector 400.

The first electrical device 500 is connected to the first mating port 416 of the electrical connector 400 by having its first and second electrical terminal assemblies 520 and 530 inserted into the first and second slots 425a, 425b, respectively, of the electrical connector 400. The electrical terminals in the form of the contact strip or flat cable of the first electrical terminal assembly 520 and the second electrical terminal assembly 530 are electrically connected respectively, to the electrical contact portions of the first plurality of electrical terminals of the electrical connector 400 protruding into the first slot 435a and to the electrical contact portions of the second plurality of electrical terminals of the electrical connector 400 protruding into the second slot 435b, achieving the electrical connection of the first electrical device 500 with the electrical connector 400.

The second electrical device 600 includes a second device housing 610 and two electrical terminal assemblies 615 supported by the second device housing 610 and composed of receptacle terminals, such as crimp terminals electrically connected with cables. The electrical terminals in each of the electrical terminal assemblies 615 are spaced apart in the same manner as the electrical terminals 460 of the electrical connector 400. A clamping device 620 is used to secure each of the electrical terminal assemblies (or each of the electrical terminals) to the second device housing 610. The clamping device 620 may be in the form of a terminal position assurance (TPA) member that is snapped to the second device housing 610 and abuts each of the electrical terminals. The clamping device 620 in the form of the TPA member improves the connection stability between each of the electrical terminals and the second device housing 610, thereby improving the electrical contact performance between the second electrical device 600 and the electrical connector 400.

When the second electrical device 600 is connected to the second mating port 418 of the electrical connector 400, each receptacle electrical terminal of the second electrical device 600 receives and electrically connects the pin portion 494 of a corresponding one of the electrical terminals 460 of the electrical connector 400, enabling electrical connection of the second electrical device 600 (and of a cable 617 electrically connected thereto) with the electrical connector 400.

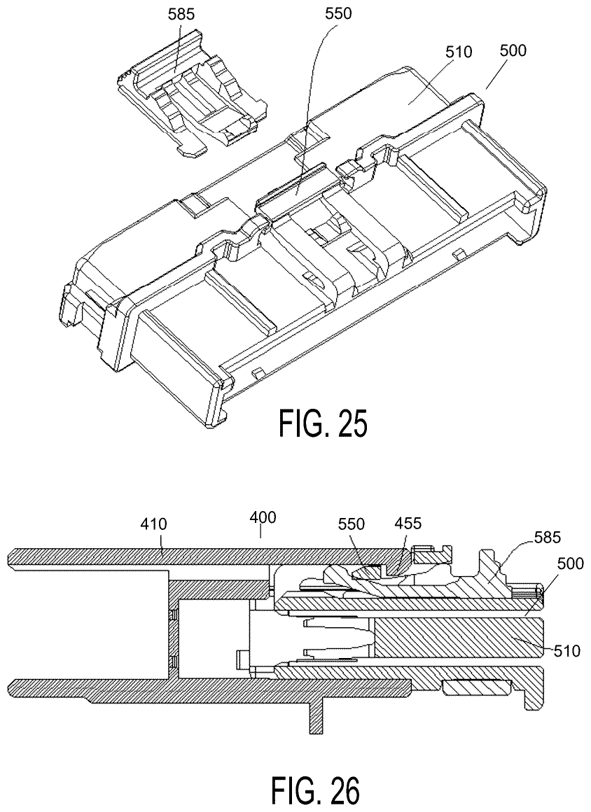

Referring to FIGS. 25 and 26, some details of the first electrical device 500 are shown. The first device housing 510 of the first electrical device 500 includes a resilient snap structure 550 (such as an elastic arm as illustrated), and the connector housing 410 of the electrical connector 400 is formed with a hook portion 455 (FIG. 26) configured to be engaged with the resilient snap structure 550 of the first electrical device 500.

As the first electrical device 500 is connected to the electrical connector 400 or inserted into the first mating port 416 of the electrical connector 400, the hook portion 455 of the connector housing 410 of the electrical connector 400 engages and elastically deforms the resilient snap structure 550 on the first device housing 510 of the first electrical device 500, allowing the first device housing 510 of the first electrical device 500 to be further inserted into the housing cavity 415 of the electrical connector 400. Having been moved over the hook portion 455 of the connector housing 410, the resilient snap structure 550 returns back to its original position under an elastic force, and the resilient snap structure 550 is engaged with the hook portion 115 in a snap-fit manner. The resilient snap structure 550 cooperates with the hook portion 455, achieving automatic locking between the electrical connector (the connector housing 410) and the first electrical device 500 (the first device housing 510), and thereby improving the convenience and reliability of connection between the first electrical device 500 and the electrical connector 400.

The first electrical device 500 may further include a locking device configured for locking the resilient snap structure 550 and the hook portion 115 in an engaged state or position. The locking device may be in the form of a connector position assurance (CPA) member 585. As shown in the cross-sectional view of FIG. 26, the CPA member 585 is connected to the first device housing 510 of the first electrical device 500 and abuts the resilient snap structure 550, which limits the movement of the resilient snap structure 550 in the form of an elastic arm, prevents the resilient snap structure 550 from accidental disengagement from the hook portion 455 to cause the electrical connector 400 (the connector housing 410) to be disengaged from the first electrical device 500 (the first device housing 510), and further improves the connection stability between the electrical connector and the first electrical device 500.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

The embodiments of the present application are described with reference to the accompanying drawings, and directional terms used in the description should be understood with reference to the placement or orientation of components in the related drawings. If the placement or orientation of components in the drawings is changed, the directional terms shall be interpreted accordingly.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

It should be understood that, unless otherwise explicitly specified and limited, terms such as “assembly”, “connection”, “attachment”, and “securement” between A and B should be understood in a broad sense. Taking “connection” as an example, unless otherwise explicitly specified and limited, “connection” may refer to a mechanical connection or an electrical connecting connection; “connection” may refer to a direct “connection” or an indirect “connection” via an intermediate element; “connection” may refer to a detachable or non-detachable “connection” or “connection” in an integrated manner. One of ordinary skill in the art may understand specific meanings of the foregoing terms in this application based on a specific situation.

Without departing from the spirit of the present application, those skilled in the art can make various changes, modifications and improvements to various details shown in the drawings and described above after reading the above description, and these changes, modifications and improvements are also considered to fall within the protection scope of the present application.

What is claimed is:

1. An electrical connector configured for electrically connecting a first electrical device and a second electrical device, the electrical connector comprising:
a housing comprising a cavity extending in a first direction;
a base separating the cavity of the housing into first and second slots spaced apart in the first direction, the first and second slots configured to receive the first and second electrical devices, respectively; and
a plurality of electrical terminals, each of the plurality of electrical terminals comprising a mounting portion fixedly held by the base, and first and second arms extending in opposite directions from the mounting portion and movable relative to the base, the first arm comprising a mating portion protruding into the first slot, and the second arm comprising a mating portion protruding into the second slot.

2. The electrical connector of claim 1, wherein:
each of the plurality of electrical terminals comprises third and fourth arms extending in the opposite directions from the mounting portion and movable relative to the base, the third arm extending parallel to the first arm and offset from the first arm in a second direction perpendicular to the first direction and comprising a mating portion protruding into the first slot, the fourth arm extending parallel to the second arm and offset in the second direction from the second arm and comprising a mating portion protruding into the second slot.

3. The electrical connector of claim 2, wherein, for each of the plurality of electrical terminals:
the first arm extends farther from the mounting portion than the third arm in the first direction such that contact portions of the mating portions of the first and third arms are spaced apart in the first direction, and
the second arm extends farther from the mounting portion than the fourth arm in the first direction such that contact portions of the mating portions of the second and fourth arms are spaced apart in the first direction.

4. The electrical connector of claim 3, wherein:
the contact portions of the mating portions of the first, second, third and fourth arms are aligned in the first direction.

5. The electrical connector of claim 4, wherein:
the mating portions of the first and second arms each have a first inclined surface extending obliquely in the second direction from the respective contact portion to a free end of the respective arm in the first direction; and
the mating portions of the third and fourth arms each have a second inclined surface extending obliquely in the second direction from the respective contact portion to a free end of the respective arm in the first direction.

6. The electrical connector of claim 2, wherein, for each of the plurality of electrical terminals:
the mounting portion comprises a first surface abutting the base, and
the first and second arms extends from or near the first surface of the mounting portion.

7. The electrical connector of claim 6, wherein:
the first surface of the mounting portion comprises at least one first protrusion protruding in the second direction; and
the base comprises at least one first recess configured to receive the at least one first protrusion.

8. The electrical connector of claim 7, wherein:
the mounting portion comprises a second surface opposite to the first surface and at least two second protrusions protruding from the second surface, the at least two second protrusions spaced apart in the first direction.

9. The electrical connector of claim 8, wherein:
the base comprises a platform disposed between the first slot and the second slot;
the platform comprises a plurality of ribs each extending in the first direction and protruding between adjacent terminal channels; and
the base separates each of the first and second slots into subslots in the second direction.

10. A connector assembly comprising:
a first electrical device comprising a plurality of first electrical terminals;
a second electrical device comprising a plurality of second electrical terminals; and
an electrical connector comprising:
a housing comprising a first slot and a second slot, and
a plurality of electrical terminals, each of the plurality of electrical terminals comprising a first arm having a mating contact portion in the first slot and contacting a respective first electrical terminal of the first electrical device, and a second arm having a mating contact portion in the second slot and contacting a respective second electrical terminal of the second electrical device.

11. The connector assembly of claim 10, wherein:
each of the first and second electrical devices comprises a flat cable terminal assembly having a plurality of flat cable terminals or a receptacle terminal assembly having a plurality of receptacle electrical terminals.

12. The connector assembly of claim 10, wherein:
the housing of the electrical connector comprises a support portion disposed adjacent to the first slot and comprising a slit in communication with the first slot; and
the first electrical device comprises a flat cable terminal assembly partially inserted into the first slot through the slit.

13. The connector assembly of claim 12, wherein:
the second electrical device comprises a receptacle terminal assembly having a plurality of receptacle electrical terminals.

14. The connector assembly of claim 11, wherein:
the flat cable terminal assembly is a flexible flat cable (FFC) or a flexible printed cable (FPC).

15. An electrical connector comprising:
a housing comprising a cavity extending in a first direction; and
a terminal assembly disposed within the cavity, the terminal assembly comprising:
a base comprising a first base surface and a second base surface opposite to each other in a second direction perpendicular to the first direction, at least one of the first base surface and the second base surface having a plurality of terminal channels extending into the base in the second direction, the plurality of terminal channels spaced apart in a third direction perpendicular to both the first direction and the second direction, and
a plurality of electrical terminals disposed in respective terminal channels of the plurality of terminal channels of the base, each of the plurality of electrical terminals comprising a retention portion, a pin portion extending from the retention portion and out of the respective terminal channel in the first direction, and an arm portion extending from the retention portion and opposite to the pin portion into a slot between the at least one base surface and an opposing inner surface of the housing, the arm portion configured to deflect toward a bottom of the respective terminal channel upon an insertion of a mating electrical device.

16. The electrical connector of claim 15, wherein:
the base comprises a first portion having a first surface portion, and a second portion connected to the first portion in the first direction and having a second surface portion;
the first surface portion is offset toward the inner surface of the housing in the second direction from the second surface portion; and
the slot is bounded between the second surface portion and the inner surface of the housing.

17. The electrical connector of claim 16, wherein, for each of the plurality of electrical terminals:
the retention portion is received within a channel segment of the respective terminal channel that is within the first portion of the base,
the arm portion is received within a channel segment of the respective terminal channel that is within the second portion of the base, and
the pin portion protrudes out from the first portion of the base in the first direction.

18. The electrical connector of claim 17, wherein the arm portion comprises:
a first arm extending from the retention portion and comprising a first arm contact portion; and
a second arm extending from the retention portion parallel to the first arm and offset from the first arm in the second direction away from the bottom of the respective terminal channel to form a gap between the second arm and the first arm.

19. The electrical connector of claim 18, wherein:
the second arm comprises a second arm contact portion; and
the first and second arm contact portions are aligned and spaced apart in the first direction and protrude out of the respective terminal channel by a same distance.

20. A connector assembly, comprising:
the electrical connector of claim 15; and
a flat cable terminal assembly comprising a plurality of flat cable terminals coupled to respective electrical terminals of the plurality of electrical terminals of the electrical connector.
